(19) United States
(12) Patent Application Publication
(10) Pub. No.: US 2014/0357351 A1
(43) Pub. Date: Dec. 4, 2014

(54) WAGERING SYSTEM WITH UNDERLYING TIME SENSITIVE REDEEMABLE UNITS

(71) Applicant: RACING AND WAGERING WESTERN AUSTRALIA, Perth (AU)

(72) Inventor: Scott Robert McDowell, Perth (AU)

(73) Assignee: RACING AND WAGERING WESTERN AUSTRALIA, Perth (AU)

(21) Appl. No.: 14/372,758

(22) PCT Filed: Jan. 18, 2013
(86) PCT No.: PCT/AU2013/000037

§ 371 Date: Jul. 17, 2014

(30) Foreign Application Priority Data
Jan. 19, 2012 (AU) 2012900204

(51) Int. Cl. G06Q 50/34; G07F 17/32

(52) U.S. Cl. CPC G06Q 50/34; G06Q 40/04; G07F 17/3288
USPC 463/28

(57) ABSTRACT

A wagering system (10) comprising a wager processor (12); and at least one wager terminal (14) in data and control communication with the wager processor (12). The wager processor (12) issues a plurality of redeemable units (28) linked to each wager (26) placed by a user (30) on an outcome of an event, or series of events, placed by way of the wager terminal (14). The number of redeemable units (28) to be issued is a function of at least the time at which the wager (26) is placed on said outcome.

### FIELD OF THE INVENTION

The invention relates to a wagering system with underlying time sensitive redeemable units. The invention is particularly, but not exclusively, suited to a pari-mutuel wagering system directed to the industries of racing and sports betting.

Most importantly the present invention aims to provide liquidity to customers during the life of a pari-mutuel pool, or the period prior to closure of a fixed odds book, enabling customers to actually benefit from, rather than be penalised by, subsequent increases in the demand for the proposition they previously wagered on.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Until recently, commercial wagering traditionally took one of two forms—pari-mutuel betting and fixed odds betting.

Pari-mutuel betting sees the value of a wager vary over time in response to the number of wagers placed on a particular outcome and the amount of all wagers placed on the event concerned. The wager only attracts a definitive value once the outcome of the event concerned is known. As a result all wagers placed on a particular outcome are of equal value regardless of the time the wager was placed. At the same time, the wagering organisation has certainty of revenue.

By contrast, fixed odds betting sees each wager having a fixed value as determined at the time the wager is placed in the event that the chosen outcome is successful. The fixed value to be attributed to each bet if successful is determined by the wagering organisation on the basis of the information available to them at the time the bet is placed. This also places the wagering organisation at potential for substantial gain or substantial loss depending on the exposure the wagering organisation has to the successful outcome.

It should also be noted here that fixed odds betting involves two bets. The first bet, referred to as the “back bet”, is the original bet placed with the wagering organisation (ie. you are backing a potential outcome to be successful such as a football team to win a particular match). The secondary bet, referred to as the “lay bet”, is in essence a bet on something not to happen (for example a cricket match not to end in a draw). It is only when a lay bet and back bet are matched that a wagering transaction comes into existence.

While either form of betting described above is commercially acceptable for one-off events, conventional pari-mutuel betting is less attractive in the case of events held over time, such as seasonal sporting competitions held over a number of weeks or months. Since every successful bet in a pari-mutuel pool has an equal payoff there is no incentive for customers to invest early in a pool. Looking at this from an alternate perspective, it is to a customer's benefit to delay their wager until the last possible point of investment so that any new information on the particular event is revealed and there is an idea of the likely payout for a particular outcome prior to making their investment.

This in itself attracts problems in that:
In situations where a customer intends to bet on an outcome but delays the investment the wagering organisation may lose revenue as the customer may ultimately never actually place the intended bet on the event;
Potential investments into a pari-mutuel pool may be substituted by a fixed odds bet (which may or may not be provided by the same wagering operator) to increase the customer's certainty over the likely payout;
There is no mechanism to reward customers who correctly anticipate changes in demand of outcomes within an event and in fact a conventional pari-mutuel pool actually penalises a customer who invests early when there is little demand for a particular outcome that subsequently increases in demand and provides a smaller final dividend return if successful.
To elaborate further, FIG. 1 demonstrates the relationship between the proportion of wagering investments in a pool on a specific proposition (Horse A) and its corresponding pari-mutuel returns (dividends) in a conventional pari-mutuel pool. On the basis of a ten percent (10%) pool commission (also known as the “take-out”) Horse A would have a $3.00 return if its investment represented exactly thirty percent (30%) of the total pools investments. If the proportion of investments increases to sixty percent (60%) the pari-mutuel return decreases by fifty percent (50%) to $1.50. This inverse relationship between the returns and the proportion of investments is one of the most significant reasons why conventional pari-mutuel systems do not have great utility for events occurring over a long duration and where the status of wagering is likely to change significantly over the duration of the pool being open.
It is also worth noting an additional relationship in conventional pari-mutuel pools, in that there cannot be a concurrent decrease in provisional pari-mutuel returns for all propositions as a result of a new wager in a pool. A new wager will cause the pari-mutuel returns to decrease for only the proposition which is the subject of the new wager and all other propositions will experience an increase in their pari-mutuel return as their share of the overall wagering pool decreases. An example of the conventional pari-mutuel relationship between two propositions in a head to head contest is depicted in FIG. 2.
Lack of initial investment in a prize pool may impact on a customer's perspective of the liquidity of the prize pool that in turn may deter investment in that prize pool; AND
The demand placed on the wagering organisation's systems just prior to the time when final determinations will be made on each wager may be more than such systems can cope with—again resulting in potentially lost revenue to the wagering organisation.

As a result fixed odds betting has become the product of choice for sporting events.

In recent years a third system has arrived in the form of betting exchanges, which are order-driven systems allowing customers to bet at odds sought by themselves or offered by other customers. A bet is only confirmed on a betting exchange once its risk is exactly matched by the operator with another customer or group of customers with an equal but opposite view. When betting on an exchange, customers can either place a back bet or a lay bet in a manner similar to those used by stock exchange systems to match buy and sell requests of stocks.

Thus, unless the wagering operator participates in the exchange themselves, the wagering operator has no exposure to the event and makes a profit through other streams (such as commission rates on matched bets; account fees or subscription fees).

While this third system has seen prior problems overcome and new advantages for both wagering operator and user alike, it has also introduced new problems such as:
The necessity of a matching back bet and lay bet means that the liquidity of the exchange is intimately tied in with the ability of the exchange to match bets upon recording with the exchange. This also means that the liquidity of a bet can never be guaranteed.
As mentioned above, for a bet to come into existence under a betting exchange there must be a match between the back bet and the lay bet. Thus, a user who places either a back bet or a lay bet that is not matched does not have any wager upon which they can obtain a return if the bet is successful. This may leave certain bets unfulfilled.
Secondary matched bets taking an opposite position to the original bet need to be placed by sophisticated users who seek to exit, in whole or in part, their original position.
Users who place lay bets need to have on account with the wagering operator sufficient funds to meet the lay bet if unsuccessful.

In efforts to solve one or more of these problems, new systems based on the fundamentals of a betting exchange have developed. Two such systems are that described in U.S. Pat. No. 7,233,922 owned by Cantor Index LLC and U.S. Pat. No. 7,788,158 owned by Yahoo! Inc.

U.S. Pat. No. 7,233,922 relates to the trading of financial instruments. Each financial instrument encapsulates a wager and the value of the financial instrument is determined with reference to the market's perception of the likelihood, and quantum, of return on this wager. In doing so this invention is subject to the volatility of human subjective valuation methodologies. Furthermore, trading of these financial instruments is not as of right, but can only occur when a willing counter party is found.

In addition, U.S. Pat. No. 7,233,922 contemplates the wagering operator acting as a counter party primarily when the wagering operator is seeking to act as a market maker. This poses its own problems, as the wagering operator is then at risk of loss.

Other problems inherent in this approach are:
Trading of the financial instrument is conducted on an “all or nothing” approach.

The specification does not contemplate an invention where a portion only of the financial instrument may seek to be traded; and
The differing market values attributed to each financial instrument typically encourage trading in the existing financial transactions at the expense of further wagers on the wagering proposition embodied by the financial transaction.

U.S. Pat. No. 7,788,158 offers a similar trading system. U.S. Pat. No. 7,788,158 allows for proportional trading of the “financial instruments” unlike U.S. Pat. No. 7,233,922. However, trading in U.S. Pat. No. 7,788,158 continues to follow the matched market transaction methodology also adopted by U.S. Pat. No. 7,233,922.

A further key feature of U.S. Pat. No. 7,788,158 is that wagering on an event closes at a predetermined point in time and then a pari-mutuel payoff for each correct speculation is calculated according to price functions which depend at least in part on the status of speculations at the time the speculation was received in the market. The pari-mutuel returns payable to investors whose speculation was correct will therefore differ.

However, U.S. Pat. No. 7,788,158 does not provide speculators with live values in relation to their pari-mutuel return prior to the closure of the wagering pool nor does it provide a mechanism for comparing the alternative values of holding versus liquidating the underlying transaction directly with the operator at any point prior to the closure of the wagering pool.

It is therefore an object of the present invention to produce a wager system that alleviates, in whole or in part, at least one of the abovementioned problems.

### DICTIONARY OF TERMS

Understanding of the present invention will be enhanced by an understanding of the following terms as used in the present specification:

Back Bet means the wager placed on an outcome thought to be successful.

Lay Bet means the reverse wager to the Back Bet, i.e. a wager that any outcome other than the outcome the subject of the back bet will be successful.

Redeemable Unit means a unit issued by the wagering operator in connection with an underlying wager which a customer has the option to, but not the obligation, to redeem prior to the closing of wagering activity on a particular racing, sporting or other type of event.

Redeemable Unit Value means the actual value of each Redeemable Unit associated with an underlying wager which may fluctuate during the life of wagering activity as a result of changes in the status of wagering in accordance with the invention summary outlined.

The actual formulas used to determine the Redeemable Unit Value are described in more detail below.

Redemption Payout means the amount of funds returned to a customer who exercises their right, but not obligation, to redeem some or all of their Redeemable Units prior to the closure of wagering activity on a particular racing, sporting or other type of event.

TPI means the Total Pool Investment which is calculated as the gross investments into a particular pool.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is a wagering system comprising:
a wager processor; and
at least one wager terminal in data and control communication with the wager processor;
   where the wager processor is operable to issue a plurality of redeemable units linked to a wager placed by a user on an outcome of an event, or series of events, placed by way of the wager terminal, the number of redeemable units so issued being a function of at least the time at which the wager is placed on said outcome.

The value of each redeemable unit sought to be redeemed may be a function of at least the status of wagering at the time of placement of the wager and the status of wagering at the time of redemption of the redeemable unit.

An adjustment may be made to the value of all redeemable units commensurate with the value of redemption profits made by users at the time of the adjustment.

Following each tender of at least one redeemable unit for redemption, the wager processor may operate to calculate a settled bet percentage and following calculation, to reduce the amount of the linked wager by an amount proportional to the settled bet percentage.

The user may quantify the number of redeemable units to be tendered for redemption as a percentage of the total number of redeemable units issued to them that have not already been redeemed. Furthermore, each issued redeemable unit may be redeemed at any time up to a predetermined time before completion of the event, or completion of the last event in the series of events.

The number of redeemable units issued by the wager processor may be a function of at least the current value of all redeemable units issued in respect of the outcome the subject of the wager.

Preferably, the value of each redeemable unit is updated after the placement of a new wager and also on redemption of at least one redeemable unit. The value of each redeemable unit is preferably a function of the value of all redeemable units not yet redeemed in respect of a proposition divided by the value of all redeemable units for all propositions.

The wager processor may operate to settle redeemable units tendered for redemption on one of the following bases: first-in-time; last-in-time; user selection.

When an outcome becomes a dead proposition, the amount wagered on that outcome being proportionally distributed amongst the redeemable units of all other outcomes. This proportional distribution amongst the redeemable units may be determined by reference to the value of all redeemable units issued in respect of an outcome as a percentage, as determined prior to the redistribution, of the number of redeemable units issued in respect of all outcomes.

When the user has entered a set of wagering information sufficient to allow the wagering terminal to identify the type, outcome and event on which a proposed wager is to be placed, the wagering terminal may request a potential return amount on that outcome for that event from the wagering processor and operates to communicate the potential return amount to the user. If the user subsequently changes the set of wagering information, and the changed set of wagering information is sufficient to allow the wagering terminal to identify a new type, outcome and/or event on which a proposed wager is to be placed, the wagering terminal may again request from the wagering processor the new potential return amount on the outcome for the event identified by the new wagering information and communicates the new potential return amount to the user.

The user may enter in the set of wagering information through a graphical user interface.

The wager processor may calculate the potential return for a wager based on the value of the non-redeemed portion of all amounts wagered on the outcome minus a commission amount. In doing so, the value of the non-redeemed portion of all amounts wagered on the outcome preferably takes into account the amount of any new wager placed and/or the amount of any new redemptions.

The commission rate is time-sensitive such that a lesser commission rate is applied the earlier the transaction attracting the commission rate is initiated.

The wager placed may be a fixed-odds wager. Alternatively, the wager placed may be a pari-mutuel wager.

Each provisional dividend for an outcome and the value of each redeemable unit related to wagers of at least two wagering types may be determined by reference to the value of a single wagering pool.

The user can specify a set of wagering conditions using client software, the client software operable to initiate placement of a wager by way of the wager terminal when the set of wagering conditions is met. Similarly, the user can specify a set of redemption conditions relating to a wager using the client software, the client software operable to communicate the set of redemption conditions to the wager processor such that, when the set of redemption conditions is met, the wager processor automatically operates to redeem a specified quantity of the user's redeemable units linked to that wager. The set of redemption conditions may include conditions that are based on data provided to the wager processor by an external informational source.

The user may initiate the placement of a wager, or the tender of at least one redeemable unit for redemption, by way of interactive voice recognition techniques.

The user may be presented with pre- and post-transaction details regarding the value of the wager proposed to be placed. The user may also be presented with details regarding the number and/or value of redeemable units to be issued in respect of a wager proposed to be placed.

The wagering terminal may operate to display historical information regarding a user's wagers and linked redeemable units.

Wagers may be placed by a wager operator as seeding wagers.

The wager terminal may take the form of a dedicated terminal located at a betting outlet or the location where an event on which a wager can be placed is conducted. Alternatively, the wager terminal may take the form of a software application executable on a mobile computing device. In the latter circumstance, the mobile computing device may be one of the following: a notebook computer; a tablet computer; an internet-enabled mobile phone. The mobile computing device may connect to the wagering processor either directly through a wired or wireless network or connected to the wagering processor via the Internet.

As a further alternative, the wager processor and the at least one wager terminal may be integrated within a single processing device.

The wagering processor may communicate details of an amount representing the value of the redeemable units held by a user in relation to a wager either on a per unit or total holding basis.

The wagering processor may publicly communicate details of an amount representing the current unit value of a redeemable unit for each possible wager on the event. The means of public communication may be any of the following: television; radio; on-line blog.

In accordance with a second aspect of the present invention there is a wager processor for use with a wagering system, where when the wager processor receives details from a wager terminal of a wager placed by a user on an outcome of an event, or series of events, by way of the wager terminal, the wager processor operates to issue a plurality of redeemable units linked to the wager, the number of redeemable units so issued being a function of at least the time at which the wager is placed on said outcome.

In accordance with a third aspect of the invention there is a wager terminal in data and control communication with a wager processor, the wager terminal operable to receive details from a user of a wager on an outcome of an event, or series of events, and communicate the details to the wager processor, the wager processor thereafter operable to issue a plurality of redeemable units linked to the wager, the number of redeemable units so issued being a function of at least the time at which the wager is placed on said outcome.

In accordance with a fourth aspect of the invention there is a method of operating a wagering system comprising the steps of:
placing a wager on an outcome of an event, or series of events;
issuing a number of redeemable units linked to the wager, the number of redeemable units so issued being a function of at least the time at which the wager is placed on said outcome.

In accordance with a fifth aspect of the invention there is a computer readable medium having software recorded thereon that, when executed by an appropriate processing device, performs a method of operating a wagering system comprising the steps of:
placing a wager on an outcome of an event, or series of events;
issuing a number of redeemable units linked to the wager, the number of redeemable units so issued being a function of at least the time at which the wager is placed on said outcome.

### BRIEF DESCRIPTION OF THE DRAWINGS

The invention will now be described, by way of example only, with reference to the accompanying drawings, in which:

FIG. 1 is a graph showing the relationship between the proportion of wagering investments in a pool on a specific proposition and its corresponding pari-mutuel returns in a conventional pari-mutuel pool of the prior art.

FIG. 2 is a graph showing the conventional pari-mutuel relationship between two propositions in a head to head contest.

FIG. 3 is a schematic representation of a pari-mutuel wagering system according to a first embodiment of the invention.

FIG. 4 is a table illustrating example redeemable unit allocation scenarios without reference to a processing framework built upon the invention.

FIG. 5 is a table illustrating the allocation of redeemable units according to a second example and without reference to the processing framework shown in FIG. 3.

FIG. 6 is the table shown in FIG. 5 modified to include redemption transactions.

FIG. 7 is a graph showing the potential pari-mutuel returns and their inverse relationship with the redeemable unit value as per the second example.

FIG. 8 is a graph showing pari-mutuel returns for the two teams indicated in the second example.

FIGS. 9 and 10 are tables showing the methodology of a third example based on the transaction and redemption history as used in the second example.

FIG. 11 is a table showing the methodology to calculate redeemable unit values (RU values) in the third example.

FIG. 12 is a provisional dividend comparison between wagers placed on Spain and Italy according to the methodology of the third example.

FIGS. 13 and 14 show the relationship between a redeemable unit value and provisional pari-mutuel return for Spain and Italy respectively according to the methodology of the third example.

FIG. 15 shows an example calculation of a total RU live value for each horse in a three (3) horse race.

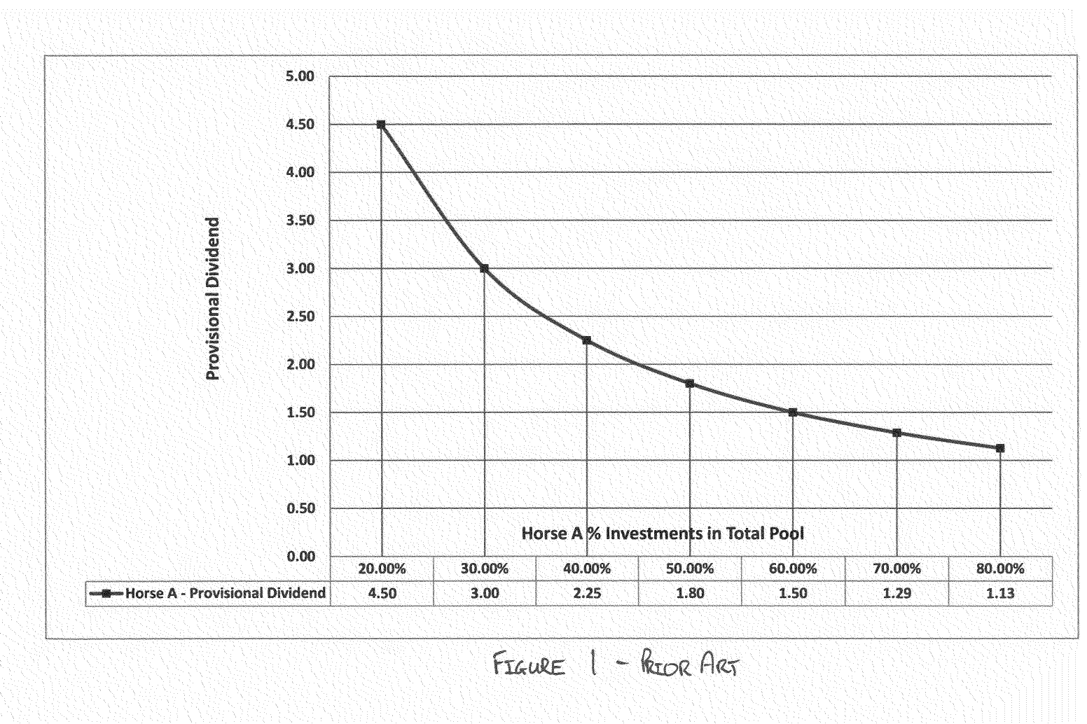

### PREFERRED EMBODIMENTS OF THE INVENTION

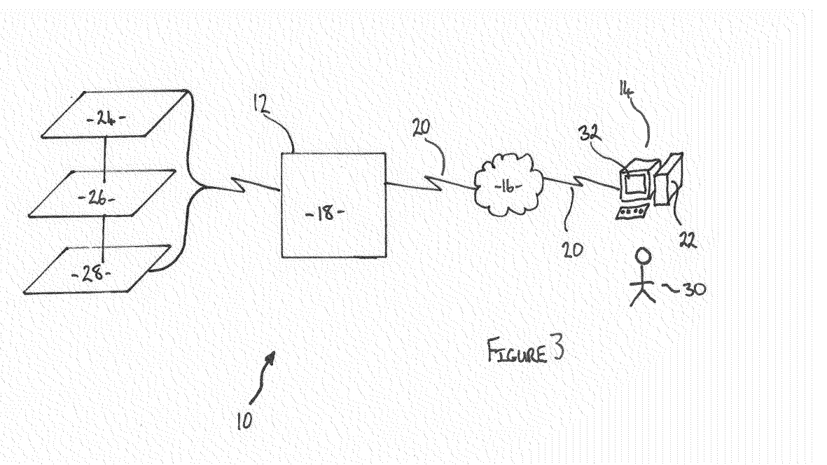

In accordance with a first embodiment of the invention there is a wagering system 10 as shown in FIG. 3. The wagering system 10 comprises a wager processor 12 and at least one wager terminal 14. Each wager terminal 14 is in data and control communication with the wager processor 12.

In this embodiment, the wager processor 12 is a computer system generally in the form known as a server. The components of such a computer system would be well known to the person skilled in the art and thus will not be described in more detail hereafter except as where relevant to a proper understanding of the invention.

Similarly, the at least one wager terminal 14 is a computer system in the form of an internet-enabled desktop computer. Again, the components of such a computer system would be well known to the person skilled in the art and thus will not be described in more detail hereafter except as where relevant to a proper understanding of the invention.

Communication between the wager processor 12 and each wager terminal 14 is via the internet 16.

The invention will now be described in the context of a number of examples aimed at illustrating the core concepts underlying the invention. The first example illustrates the general processing and data flow underlying the invention with minimal reference to representative data. The remaining examples illustrate the invention with greater reference to data values, but without further reference to the processing and dataflow framework described in the first example except where necessary to properly explain the relevant example.

### Example 1

In the first example, backend software 18 stored on the wager processor 12 is executed. Execution of the backend software 18 causes the wager processor 12 to seek to establish, and maintain, a data and control communication link 20 with each wager terminal 14 via the internet 16.

At the same time, client-side software 22 stored on the wager terminal 14 is executed. Execution of the client-side software 22 causes the wager terminal 14 to properly respond to any attempt to establish the communication link 20 and thereafter maintain the established communication link 20.

Following attempts to establish a communication link 20 with each wager terminal 14, and provided that at least one communication link 20 is established, the backend software 18 operates to create a series of data structures representing:
at least one wagering pool 24;
a wager 26; and
a redeemable unit 28.

The relationship between these data structures will be explained in more detail below.

A user 30 seeking to place a wager approaches a wager terminal 14. Client-side software 22 executing on the wager terminal 14 guides the user 30 through preliminaries associated with the placing of the wager by way of a display 32.

In this example, the user is first guided to select the event on which they wish to place the wager. Once the event has been selected, the display operates to present three data sets to the user 30. The first data set provides information by which the user can select the outcome(s) upon which they wish to place their wager. The second data set provides information by which the user can select the type of wager to be placed, i.e. “win”, “place”, “trifecta”, “quinella”, etc.

The third data set provides information to the user in respect of the current return(s) for each potential outcome(s) associated with the event as selected by the user 30 for the wager type as selected from the second data set. In gathering together this information, the wager terminal 14 communicates with the wager processor 12 to request the current return(s) for each potential outcome in relation to the chosen event as selected by the user from the first data set and for the wager type as selected from the second data set.

The backend software 18 then calculates these return(s). In the case of the wager being of a pari-mutuel type, the potential return(s) are calculated according to the following formula:

$$PR = \frac{( WP - OC )}{NW}$$

where:
PR is the potential return (which may also be known by the person skilled in the art as the “provisional dividend”);
WP is the total value of the appropriate wagering pool for the wager type;
OC is the operator's commission; and
NW is the value of the wagering generated for the wager type presently wagered on the outcome of concern.

The calculated potential return(s) are then communicated by the wager processor 12 back to the wager terminal 14 via the communication link 20 for display as the third data set.

It should be noted that as soon as the client-side software 22 is able to identify the outcome(s) upon which the user 30 seems to be wishing to make their wager on, and the type of wager to be made, the client-side software 22 operates to display to the user 30 the potential return for each such outcome as the third data set. In this same manner, if the user 30 subsequently changes either the selected outcome(s) or the wager type, the wager terminal 14 will request the current return(s) for the combination of outcome(s) and wager type as changed.

This allows the user to obtain information on the current returns for any combination of outcome(s) and wager type prior to placement of the wager.

Once the user 30 has selected their chosen outcome(s) upon which they wish to place their wager, as well as the type of wager to be placed, the user 30 is prompted by the client-side software 22 to either enter or select the amount of the wager they wish to make.

Once selected the user 30 is shown via the display 32 a summary of their wager and asked to confirm placement of the wager. Following confirmation, the client-side software 22 operates to obtain appropriate payment for the wager. Means and systems for obtaining such payment would be well known to the person skilled in the art and therefore will not be described in more detail here.

Following confirmation of the wager and its associated payment, a wager 26 on these same terms is established by the back-end software 18 and associated with the user 30. At the same time, the back-end software 18 calculates the number of redeemable units 28 to be granted in association with the wager 26.

It should also be noted here that if the wager 26 is the first wager made in respect of a particular wager type, then the wager processor 12 also operates to establish a wagering pool 24 for that wager type.

In this example, where the wager 26 concerned is of the pari-mutuel type, the back-end software 18 uses the following formula to calculate the number of redeemable units 28 to be granted, which takes into account the status of wagering for the particular outcome at the time of making the wager:

$$N = \frac{( I \times ( 1 - K ) )}{RU Value}$$

where:
N is the number of redeemable units 28 issued;
I is the amount of the wager 26 (as a unit value representation).
K is the commission rate on allocation of a redeemable unit 28.
RU Value is the Redeemable Unit Value for the particular proposition and type of wager being bet on. In a preferred variant this value is calculated inclusive of the particular pari-mutuel wager 26 being made.

Note that in the context of this embodiment, in determining the conversion rate of currency to unit values a ratio of 1:1 is used, i.e. $1 represents 1 unit.

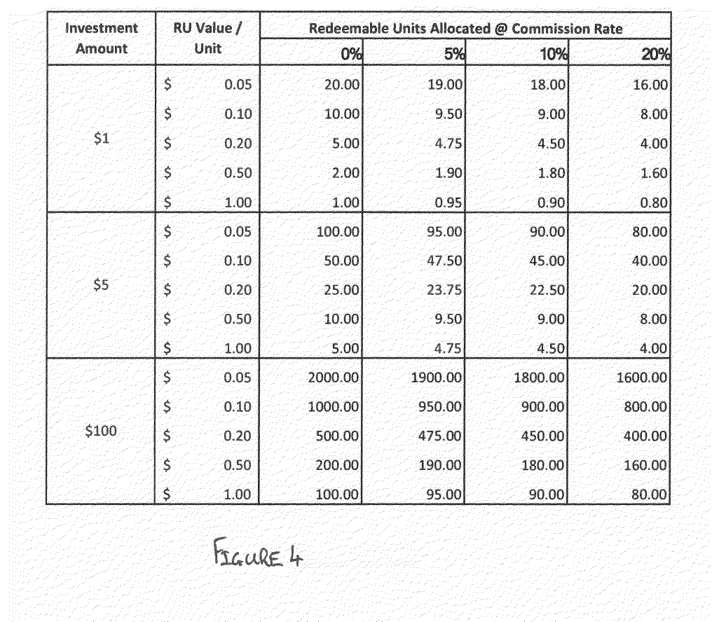

A table showing various example scenarios and the corresponding number of redeemable units 28 to be issued for each such example is set out in FIG. 4.

The issued redeemable units 28 are then available to the user 30 to be redeemed directly with the entity behind the wagering system 10 at any time up to a predetermined time period before the event on which the wager 26 has been placed.

Up to the threshold time period before the event concerned when redeemable units 28 can no longer be redeemed, the user 30 may obtain details of the redemptive value of the redeemable units 28 issued to them either on a per unit or total holding basis. Obtaining these details will typically be by way of the client side software 22. However, use may also be made of existing communication channels for the event, such as television, radio, on-line blogging, etc. to convey real-time redemptive values to users 30.

In seeking to redeem one or more of the redeemable units 28, the user 30 approaches the wager terminal 14. Selecting the appropriate option made available by the client-side software 22 initiates identification procedures which the user 30 must satisfy. These identification procedures also allow the wager terminal 14 to communicate with the wager processor 12 via the communication link 20 to request the number of redeemable units 28 the user 30 has available for redemption.

The back-end software 18, using ordinary database query techniques, is then able to determine this number and convey the value back to the wager terminal 14. The wager terminal 14 then displays this value to the user 30 by way of the display 32.

The user 30 is then able to select the number of redeemable units 28 they wish to redeem. Once an indication of the number of redeemable units 28 to be redeemed is made by the user 30, the client-side software 22 operates to:
Convey to the user 30 the number of redeemable units 28 they will have after this redemption, the value of the redemption, the reduced face value of the associated wager 26 (which will be zero if all relevant units are redeemed) and the present potential value of the reduced wager 26 by way of the provisional dividend applicable at that point in time; and
Ask for confirmation of the redemption.

If the user confirms redemption, the redemption payout value of each redeemable unit 28 in this pari-mutuel wager example is calculated and processed in accordance with the following formula:

RP=N×RU Value×(1−K)

where:
RP is the redemptions payout;
N is the number of redeemable units 28 actually redeemed;
RU Value is the redeemable unit value for the particular proposition which is being redeemed at the point of redemption and inclusive of the redemption transaction occurring; and
K is the commission rate on redemption payments. As with other commission rates, this rate may be nil.

As the number of redeemable units 28 actually redeemed impacts on the original wager 26, a calculation is made of the settled bet percentage (“SBP”).

$$SBP = {\sum }_{i = 1}^{j} \frac{{N}_{i}}{RUI}$$

where:
j represents the total number of times a redemption has been completed in respect of the linked wager;
Nᵢ represents the number of redeemable units 28 actually redeemed at completion of the relevant redemption request; and
RUI represents the original number of redeemable units 28 issued to the user 30 for the wager 26.

The SBP value is then multiplied by the original wager 26 amount to determine the settled component of the original wager 26. The original wager 26 is then decremented by this settled amount to determine the unsettled portion of the wager 26, i.e. the amount of the wager 26 that will be paid out on in the event that the wagered outcome is successful.

In this example, as wagers 26 are unit based and not proportional, in the event that the settled amount is not a unit multiple, the settled amount is rounded up to the next unit multiple.

This redemption process then repeats as and when desired by the user 30 up to the predetermined time period before the event, or final of a series of events, upon which the wager 26 is placed is finally determined.

Following determination of the event, or final of a series of events, upon which the wagers 26 are placed, the back end software 18 determines each winning outcome and the associated wagers 26 on these outcomes. A unit payout is then calculated according to ordinary principles for each such outcome (as determined by the betting system used—i.e. pari-mutuel or fixed-odds), taking into account the relevant settled bet percentages for users 30 who have partially redeemed their original redeemable unit 28 allocation and the impact, if any, of adjustments made to the value of the wagering pool 24 due to the cumulative redemption position of users 30.

As and when each user 30 seeks to cash in on their successful wagers 26 the user 30 is paid either:
The unit face value of the wager 26 multiplied by the unit payout; OR
If one or more redeemable units 28 have been redeemed prior to the predetermined time period, the number of units represented by the part-settled wager 26 multiplied by the unit payout.

In relation to the second example hereafter described, it will be assumed that the plurality of users 30 initiate placements of pari-mutuel wagers 26, redemptions, etc. using the mechanisms described in the first example and therefore will not be reiterated here.

### Example 2

In this second example, assume a football match between two teams, Spain and Italy.

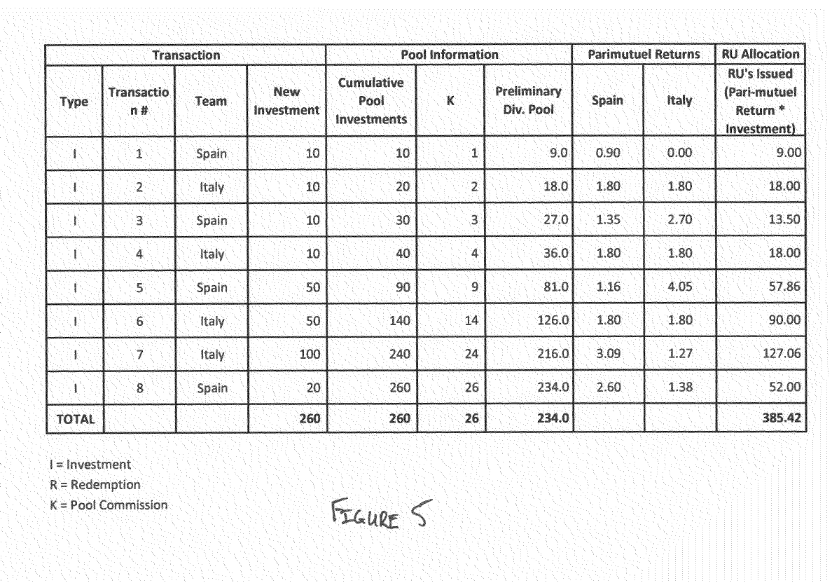

Eight pari-mutuel wagers 26 are placed on this competition over time and before the deadline for placing pari-mutuel wagers 26 expires. The eight pari-mutuel wagers 26, and their impact on the pari-mutuel wagering pool 24 are shown in detail in FIG. 5.

Furthermore, as each pari-mutuel wager 26 is placed, a correlating number of redeemable units 28 are issued to the user 30. For the purposes of demonstrating the utility of the illustrated methodology for calculating and allocating the redeemable units 28 issued for each pari-mutuel wager 26, in this example the number of redeemable units 28 issued are calculated using a methodology reflective of the applicable provisional dividend at the time of placement of each pari-mutuel wager 26 as shown in FIG. 5.

Thus, assuming a commission rate applicable to each wagering pool 24 of ten percent (10%), in this example redeemable units 28 are allocated based upon the following formula:

N=I×PR

where:
N is the number of redeemable units 28 allocated;
I is the amount of the wager 26 (as a unit value representation); and
PR is the pari-mutuel return as represented by the provisional dividend at the time of the wager 26 and in its preferred variation this return will be inclusive of the particular wager 26 being made.

Taking these figures, if no redemptions are made of the redeemable units 28 prior to the deadline passing for initiating such redemptions, all 385.42 redeemable units 28 expire (and are essentially cancelled). With no redemptions, each pari-mutuel wager 26 retains its initial face value and thus calculation of the potential dividend for each outcome is based on ordinary pari-mutuel principles. To elaborate with reference to the provided figures, the pari-mutuel payout on Spain, if Spain wins the sporting competition, is $2.60. The pari-mutuel payout on Italy, if Italy wins the football match, is $1.38.

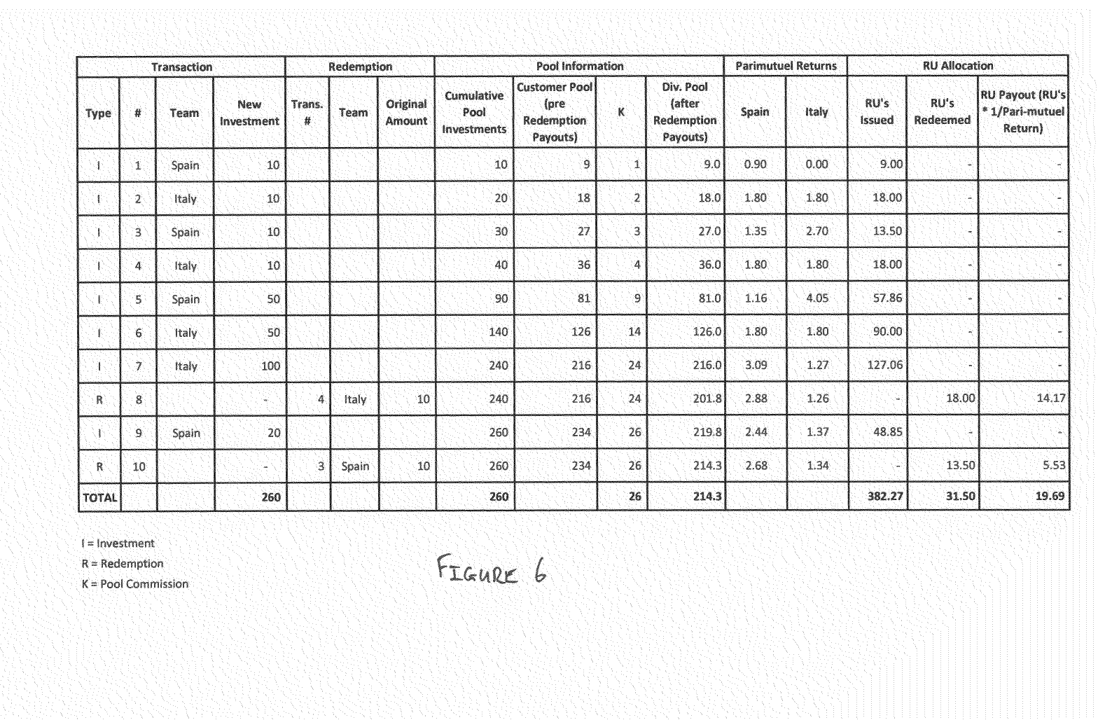

To illustrate better the impact the redeemable units 28 have on the pari-mutuel dividends, assume that prior to the last pari-mutuel wager 26 being placed, the user 30 who placed the fourth pari-mutuel wager 26 (the “first redeemer”) seeks to exit their original pari-mutuel wager 26. Furthermore, just prior to expiry of the deadline for redeeming the redeemable units 28, the user 30 who placed the third bet (the “second redeemer”) seeks to exit their original pari-mutuel wager 26 (see FIG. 6). Also assume for the purpose of this example that the value of each redeemable unit is based upon the following formula:

$$RUV = \frac{1}{PR}$$

where:
RUV is the redeemable unit value for each redeemable unit on issue; and
PR is the pari-mutuel return on a per dollar of investment basis as represented by the provisional dividend at the time of the redemption transaction and in this example the return will be inclusive of the particular redemption occurring.

As can be inferred from the data shown in the table at FIG. 6, the redemption by the first redeemer is made when each redeemable unit 28 in relation to Italy is valued at $0.79 (being 1 divided by the applicable provisional dividend of $1.26 at the point the redemption occurs). As the first redeemer was issued with 18.00 redeemable units 28 this presents the first redeemer with a redemption payout of $14.17 and subsequently a secured profit of $4.17 on the original pari-mutuel wager 26 of $10.

At the same time, as all of the redeemable units 28 relating to the original pari-mutuel wager 26 for the first redeemer have now been redeemed, the original pari-mutuel wager 26 is considered settled in full.

In this example, it has been assumed that the wagering operator will generate a commission equal to the wagering pool 24 commission rate on the gross investments into the wagering pool 24. In order to do so the cumulative redemption payouts and thus the net redemption position (being either a profit or loss generated by users 30) is deducted from the value of the wagering pool 24. As a profit has been made from this first redemption, the profit taking by the first redeemer negatively impacts on the wagering pool 24 for the remaining users 30 who have wagers of the same type. Hence, at the time the eighth user 30 places their pari-mutuel wager on Spain, the provisional dividend on Spain has decreased from $3.09 to $2.88. This is in line with the increased proportion of overall investment on Spain

By contrast, Italy's proportion of overall investment has decreased as a result of the redemption by the first redeemer as well as the overall decrease of funds in the wagering pool 24 directly associated with the first redeemer's profitable redemption.

The provisional dividend on Spain is further decreased to $2.44 as a result of the additional investment made in the form of the $20 wager on Spain made immediately after the first redemption.

### Flaw of the Second Example—The Potential for a Downward Spiral

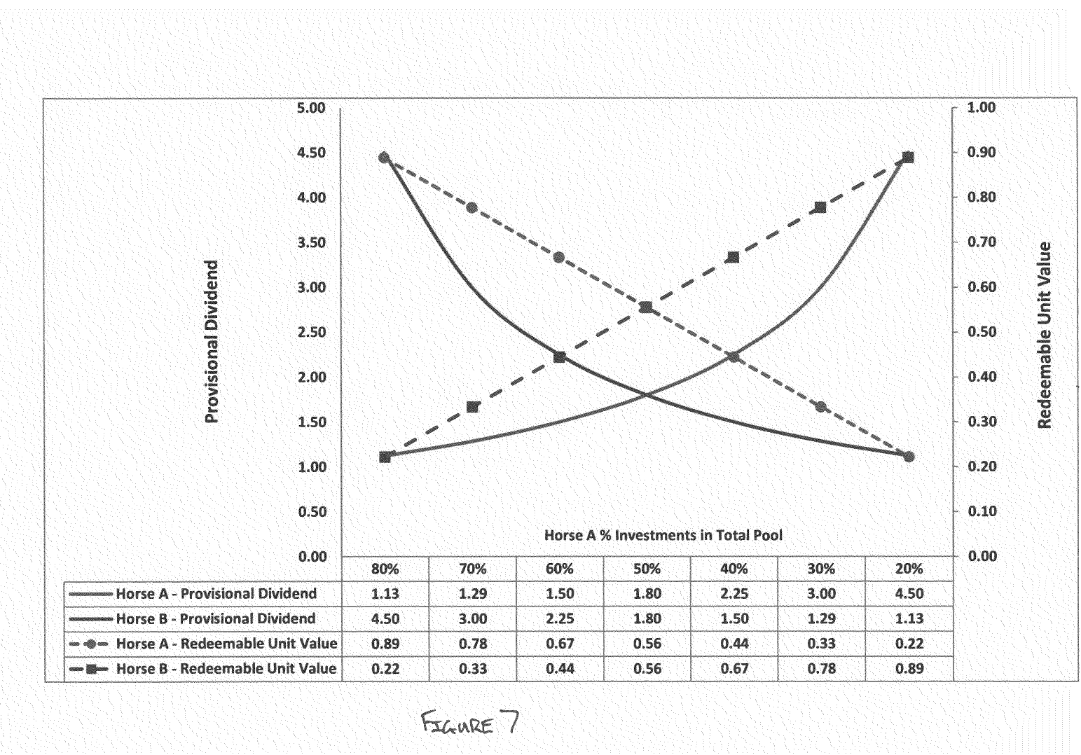

While the arrangement described in the second example is readily practicable, persons skilled in the art will appreciate that there is an inherent potential flaw if provisional pari-mutuel returns are utilised directly for calculating the number of redeemable units 28 to issue for each pari-mutuel wager 26 because of the inverse relationship between provisional pari-mutuel returns and the associated value of the redeemable units 28 (see FIG. 7 which shows the relationship where the RUV equation set out above holds true).

In circumstances where users 30 initiate profitable redemptions on any outcome during the life of the wagering pool 24 the provisional return on more than one outcome can decrease concurrently. This can then trigger the pool to spiral downwards as users 30 with outstanding redeemable units 28 will experience a commensurate increase in the value of their redeemable units 28 as provisional pari-mutuel returns decrease. Users 30 will then become motivated to initiate further profitable redemptions which will cause provisional pari-mutuel returns to progressively decrease and facilitate more redemption activity.

Accordingly, any situation where pari-mutuel returns decrease to less than the unit value of a pari-mutuel wager 26 in the wagering pool 24 is likely to cause the value of the associated redeemable units 28 to exceed the relevant unit value benchmark figure for the wagering pool 24.

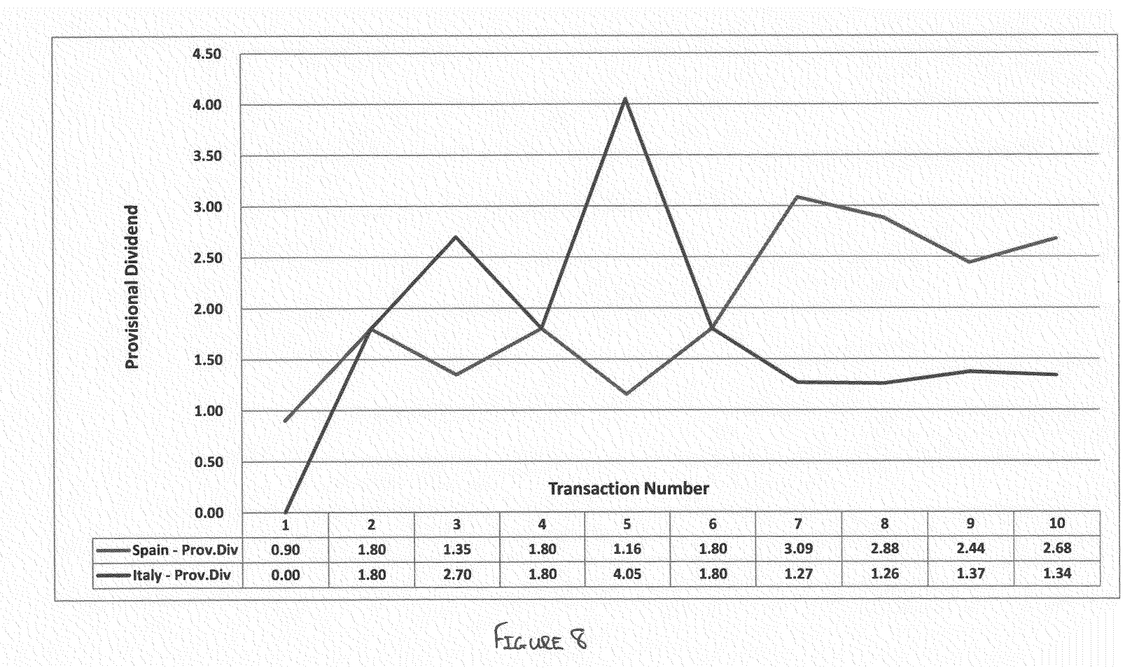

This can be evidenced by both Spain's and Italy's pari-mutuel return concurrently decreasing as a direct result of the first redemption occurring. The provisional pari-mutuel returns decreased from $3.09 to $2.88 and from $1.27 to $1.26 for Spain and Italy respectively. This is depicted in FIG. 8 from transactions 7 to 8.

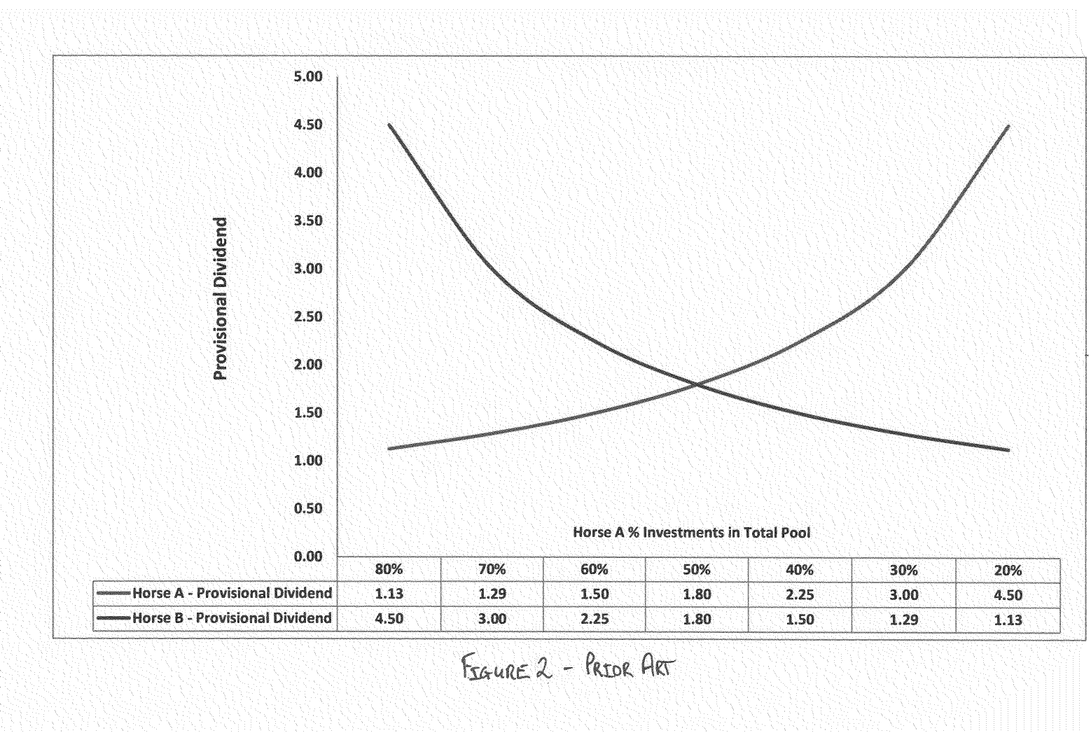

As shown for the prior art in FIG. 2, such a concurrent decrease in provisional pari-mutuel returns is not typically associated with a conventional pari-mutuel pool where any new pari-mutuel wager 26 in a wagering pool 24 will cause the pari-mutuel returns to decrease for only the proposition which is the subject of the new pari-mutuel wager 26. All other propositions will experience an increase in their pari-mutuel returns as their share of the overall wagering pool 24 has decreased.

Furthermore, if, after the second redemption occurred in the example above, additional pari-mutuel wagers 26 were placed on Italy the provisional pari-mutuel returns for Italy would decrease while, at the same time, the value of the 235.06 outstanding redeemable units 28 for pari-mutuel wagers 26 issued on Italy (being the total of 253.06 redeemable units issued for the previous transactions on Italy less the 18.00 redeemable units 28 already redeemed as part of the first redemption) would increase.

If taken beyond the scope of the data given to a real-world scenario, this would likely lead to more profit taking by way of further redemptions from users 30 that would in turn further reduce the value of the wagering pool 24. The flow on effect of this reduction in value is to also decrease the provisional pari-mutuel return on the pari-mutuel wagers 26. The inverse nature of the relationship between pari-mutuel return and redemption unit value would then see this process repeat.

Onset of such a negative cycle would result in financial loss to the wagering operator as the counterparty to the ever increasing value of redeemable units 28 which, if redeemed, may amount to an amount greater than the operator generated in the form of investments in the wagering pool 24.

### Third Example

Following analysis of the circumstances which can lead to the downward spiral identified as a significant problem of the second example, the applicant has identified a third, preferred example of the invention as it relates to pari-mutuel betting as is described hereafter.

This third example is based around three core principles:
1. The redeemable unit 28 value must be proportional not only to the status of wagering at the time of investing but also the status of wagering and the overall redemption position at the time of redemption. To elaborate, the impact of every transaction (both new investment and redemption) must be fully reflected in the pool via:
   a. adjustments to pari-mutuel returns; and
   b. automatic recalculation of redeemable unit values.
2. The sum of the proportions of net investment for each outcome within the overall pool must equal one hundred percent (100%).
3. The total pari-mutuel return (represented by the value of the wagering pool 24) must be isolated from the overall net redemption position (i.e. whether from an overall perspective the customers have yielded profits or losses on the redemption payouts).

To illustrate these principles, The same transactions as set out in the second example are now demonstrated utilising the methodology of this preferred example. Whilst the eight transactions are the same there are two key variations, namely.
The first two transactions, being a $10 wager on Spain followed by a $10 wager on Italy, represent seed transactions initiated by the wagering operator so there is an appropriate base position with which to issue redeemable units 28 to the user 30 who places the first wager 26 in respect of a particular wager type (i.e. the user who causes a wagering pool 24 to be established). The order, value and specifics of the transactions remain the same.
Secondly the operator's commission is not automatically built into the redeemable unit value (as it is in the example above by virtue of the provisional dividends, inclusive of operator commission, being used to calculate the number of redeemable units to be allocated). Rather the commission is deducted from the gross redemption payout.

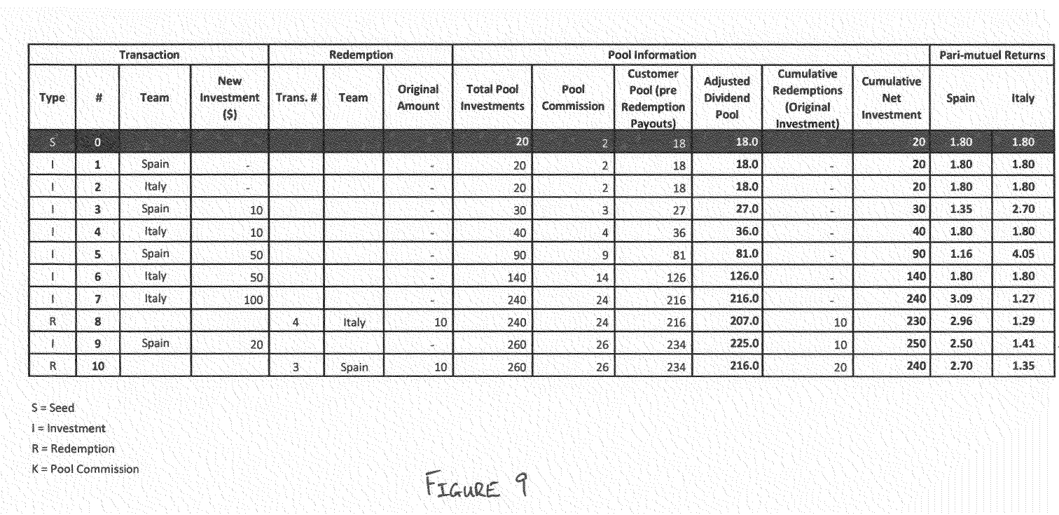

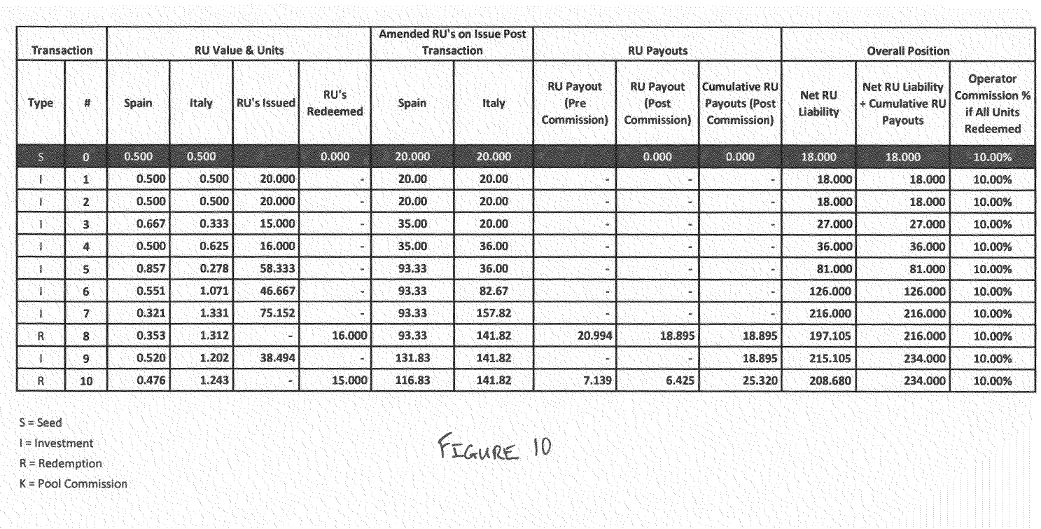

Such a system is shown in more detail in FIGS. 9 and 10.

Following placement of the two seed transactions as described above, the wagering processor 12 operates to determine the number of redeemable units 28 to be issued in respect of each wager 26. This determination is made with reference to the following formula:

$$N = \frac{I}{RU Value}$$

where:
N is the number of redeemable units 28 to be issued in respect of the wager 26.
I is the amount of the wager 26 (as a unit value representation).
RU Value=the current value of each redeemable unit.

It should be appreciated that as the RU value is updated after each and every transaction (be it the placement of a new pari-mutuel wager 26 or the redemption of one or more redeemable units 28), it is a value in a constant state of flux. However, the determination of the RU Value at any point in time is made in accordance with the following methodology:
1. The percentage of the total RU live value prior to the wager being placed is calculated for each proposition in accordance with the following formula;

$${PTRU}_{p 1} = \frac{{N}_{p 1} \times RU {Value}_{p 1}}{TRU {Value}_{- 1}}$$

where:
   PTRUₚ₁ is the percentage of total redeemable unit value for a particular proposition prior to the wager being placed;
Nₚ₁ is the number of redeemable units 28 outstanding on the particular proposition prior to the wager 26 being placed;
RU Valueₚ₁ is the redeemable unit value for the particular proposition prior to the wager 26 being placed; and
TRU Value₋₁ is the total redeemable unit value for all propositions calculated in accordance with the following formula:

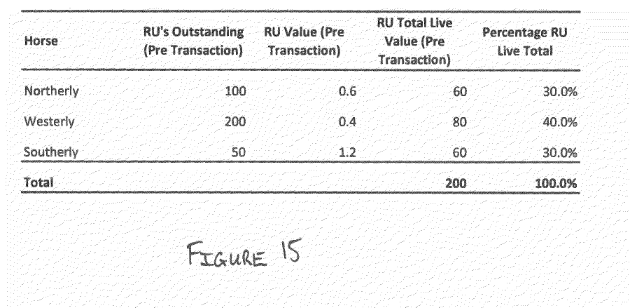

TRU Value₋₁=Σᵢ₌₁ⁿNₚᵢ×RU Valueₚᵢ
where n is the number of propositions.
FIG. 15 provides an example of this calculation to determine the percentage of the total RU live value for each horse in a 3 horse race.
2. Indicative RU live total values for each proposition are calculated post the transaction on the assumption of constant RU values. This is calculated as follows for a new wager on Proposition 1;

IRU Valueₚ₁=Nₚ₁×RU Valueₚ₁+Iₚ₁
where:
   IRU Valueₚ₁=the indicative RU total value of proposition 1;
Iₚ₁=amount of the new wager placed on proposition 1; and
Nₚ₁ and RU Valueₚ₁ is calculated as per the formula stated in point 1 above.
3. An Adjusted Percentage of the TRU Value (TRU Value_{adj %}) is then calculated according to the formula

$$PTRU {Value}_{adj \%} = \frac{IRU {Value}_{p 1}}{TRU Value}$$

Note, the value of the new wager must be factored into the TRU Value.
4. Redistribution of the impact of the new wager on all existing redeemable units (excluding the new wager). For each proposition the adjusted share of the TRU Value (TRU Valueₛ) is calculated as follows:

TRU Valueₛ=PTRU Value_{adj %}×TRU Value₋₁
5. The adjusted RU Value for each proposition is then determined taking into account the impact of the new wager 26 by way of the following equation:

$$RU {Value}_{p 1} = \frac{Tru {Value}_{s}}{{N}_{p 1}}$$

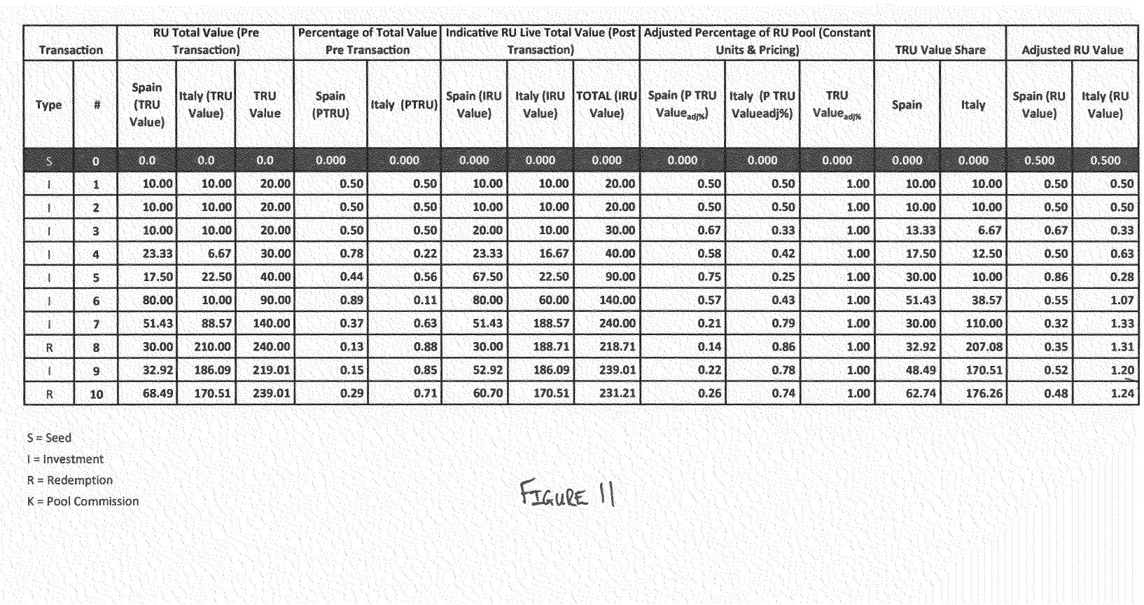

FIG. 11 provides a summary of the RU Value calculation process as described above for wagers placed in this third example.

As there is no pre-wager starting position for seed transactions an alternative formula would be utilised by the operator to determine the starting RU Value position. This would take into account the proportion of seed money to be allocated to each proposition. In this third example it was assumed Spain and Italy were allocated the same proportion of the total seed money and thus the RU Values were $0.50 each immediately prior to the first wager being placed after the seeding of the pool.

It is to be noted that the sum of the net proportions for each outcome (Spain and Italy) is one hundred percent (100%) as calculated in accordance with the following formula;

$$SP = {\sum }_{i = 1}^{j} \frac{1}{{PR}_{i}} \times ( 1 - K )$$

where:
SP=sum of the net proportions of the overall wagering pool 24;
PRᵢ represents the provisional pari-mutuel returns (provisional dividends) for each outcome at completion of each wagering transaction (investment or redemption); and
K is the commission rate on allocation of a redeemable unit 28.

Thus, the system maintains its compatibility with the second core principle of this example as espoused above at least to this point.

It should also be noted that as these first two transactions are seed transactions, they have no impact on the provisional return for a wager 26 or the redeemable unit value of their associated redeemable units 28 other than to establish such values.

With the seed transactions having been processed, the placement of the next wager on Spain sees that user issued with 15.0 redeemable units 28 as determined by the above formula. At the same time, the placement of the new wager 26 on Spain requires the value of the wagering pool 24 for Spain to be adjusted in accordance with the following formula:

WP_{Ad}=(TPI−FVR)×(1−K)

where:
WP_{Ad}=Adjusted Wagering Pool;
TPI=Total Pool Investments in accordance with its definition in the above Dictionary of Terms;
K is the applicable commission rate on investments into a pool; and
FVR=Face Value Redemption as calculated in accordance with the formula

$$FVR = {\sum }_{i = 1}^{j} {SBP}_{i} \times {A}_{i}$$

where:
   j is the number of wagers 26 placed for the wager type covered by the wagering pool 24;
   SBP; is the Settled Bet Percentage for the wager 26 under consideration calculated in accordance with the equation disclosed in relation to the first example.
   Aᵢ is the original amount of the wager 26 under consideration (as a monetary value)

While in this case the above equation does not result in the value of the adjusted wagering pool 24 being any different from the current value of the wagering pool 24, the equation makes more sense once one or more redemption transactions have been processed as the profit or loss resulting from the redemption can then be appropriately accounted for in relation to the remaining wagers 26 and redeemable units 28.

The next four transactions—all being for new wagers 26—sees the issue of a further 58.33 redeemable units being issued in relation to wagers on Spain and a further 137.82 redeemable units issued in respect of Italy. It also changes the provisional dividend for Spain from its starting position of $1.80 to $3.09, and the provisional dividend for Italy from its starting point of $1.80 to $1.27. Conversely, the value of a redeemable unit on Spain moves from its starting position of $0.500 to $0.321, while the value of a redeemable unit on Italy moves from its starting position of $0.500 to $1.331.

Following placement of each of the above wagers 26, the value of the wagering pool 24 for the relevant outcome (i.e. Spain or Italy) is adjusted as per the formula set out above. It is also noted that the rule of SP=100% remains true throughout these transactions.

The next transaction is the first redemption transaction, where the user 30 exits out of their original $10 wager on Italy. This is achieved by tendering for redemption all 16.0 redeemable units 28 allocated to this wager 26.

At the time the user 30 tenders these redeemable units 28 for redemption, the prevailing value of each redeemable unit 28 issued in respect of Italy is $1.312 while those issued in respect of Spain is $0.353. This means that the user 30 seeks a pre-commission redemption payout of $20.99. When confirmation of the redemption is received, the user 30 ends up being paid an amount of $18.89 post commission of ten percent (10%) being applied to the redemption transaction. In any event, this payout represents a profit of $8.89 (or eighty eight point nine percent (88.9%)) on the original $10 wager.

With the redemption processed, the wager processor 12 again operates to re-calculate the value of the wagering pool according to the above formula. In this case, this results in the provisional dividend for Italy increasing from $1.27 to $1.29. At the same time, the provisional dividend for Spain is reduced from $3.09 to $2.96. In this manner, it is noted that the re-calculation of the wagering pool negates the potential for the concurrent decrease of the provisional dividends for both propositions resulting from the above profit taking.

The next transaction, being a further wager 26, again changes the provisional dividend and value of each redeemable unit. In this case, the provisional dividend for Spain moves from $2.96 to $2.50, while the provisional dividend for Italy moves from $1.29 to $1.41. With respect to the value of redeemable units 28, a redeemable unit 28 on Spain moves in value from $0.353 to $0.52. A redeemable unit 28 on Italy moves in value from $1.312 to $1.202.

Continuing with the present example, the impact on provisional pari-mutuel returns is further demonstrated when the second redeemer closes out their original $10 investment on Spain for a payout of $6.42 (after commission). The provisional dividend for Spain following this redemption increases from $2.50 to $2.70 whereas the provisional dividend for Italy following the redemption reduces from $1.41 to $1.35. Users 30 who still have an open position on Italy are not disadvantaged by the slight reduction in Italy's provisional dividend as there is a commensurate increase in the value of their redeemable units 28 from $1.202 to $1.243 per unit.

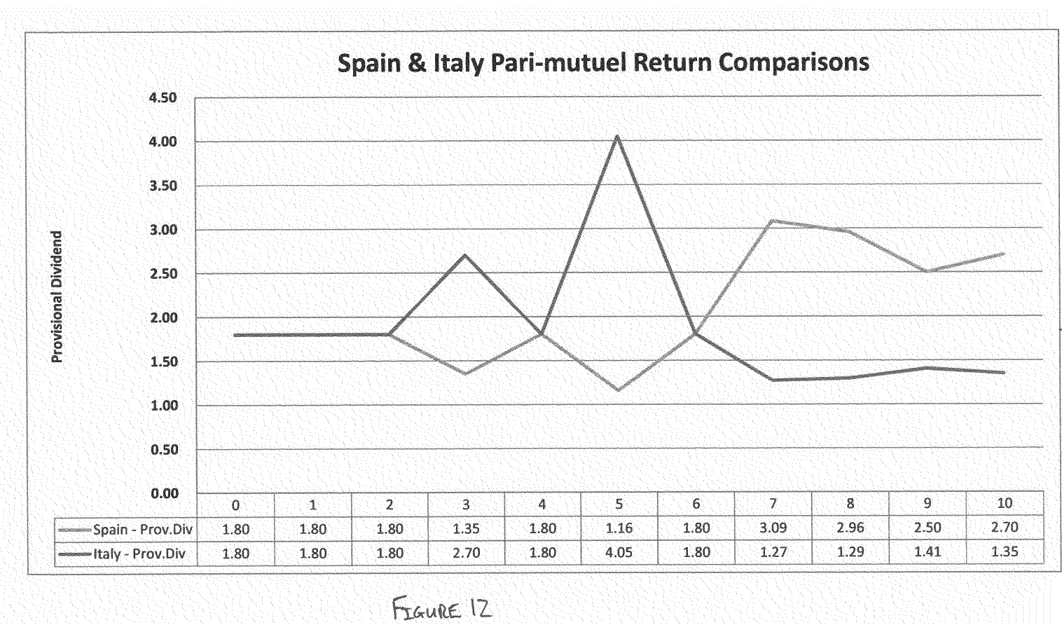

The provisional dividend comparisons between Spain and Italy are also shown graphically in FIG. 12.

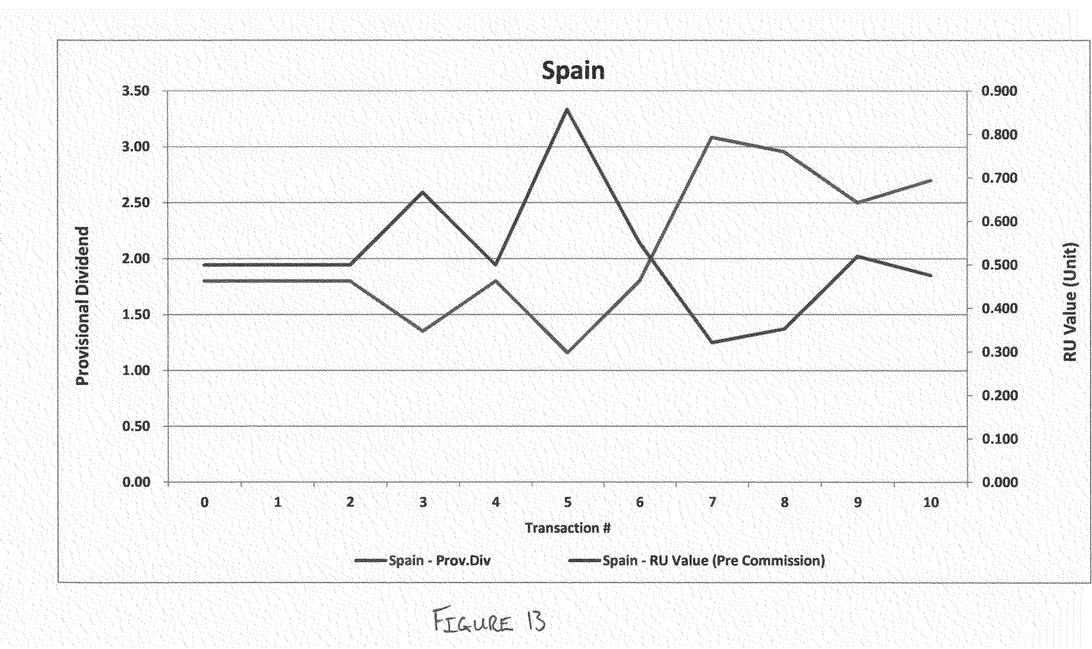

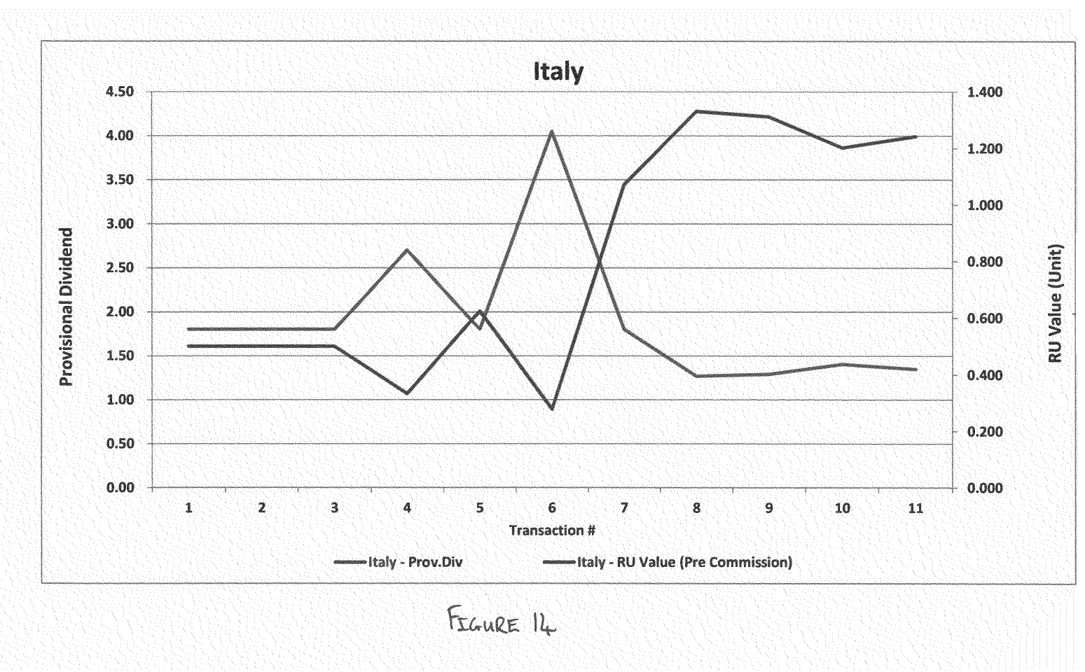

This principles illustrated by the above transactions are shown in more detail in FIGS. 13 and 14, which show the relationship between the redeemable unit value and provisional pari-mutuel returns in accordance with this example for Spain and Italy respectively. As is evident from these graphs, there is an inverse relationship between the value of each redeemable unit 28 associated with a wager 26 and the provisional pari-mutuel return for the outcome associated with that wager 26.

Immediately post the second redemption in the above example the cumulative redemption payouts equate to $25.32 (post operator's commission) on total face value pari-mutuel wagers 26 of $20.

This means that collectively the users have generated a cumulative profit of $5.32. At this point in time the cumulative redeemable value for all outstanding redeemable units 28 (i.e. redeemable units 28 which have not been cancelled due to being redeemed or the outcome of the associated wager no longer being a possibility) is 208.68, which is calculated for each team as follows;

Spain(116.83 Redeemable Units×$0.476)×(1−0.9)=$50.04

Italy(141.82 Redeemable Units×$1.243)×(1−0.9)=$158.64

The total value of the redeemable unit payouts plus RU liability for outstanding units is therefore $234, which is equal to the total pool investments ($260) less pool commission ($26). This means that whilst the users are currently in a position where they have, in aggregate, generated a profit on redemptions, the redistribution mechanism engaged after each transaction ensures the total amount available to users in the form of redemption payouts (assuming all issued Redeemable units were redeemed) still allows for the wagering operator to generate commission of ten percent (10%) of the total wagering pool 24 investment.

The end result is that the redistribution mechanisms should ensure that the sum of all of the gains (both realised and unrealised) in the value of redeemable units 28 equals the sum of all losses (again, both realised and unrealised) in value of redeemable units 28.

### Incorporation of “Dead Propositions”

It should be appreciated by the person skilled in the art that the examples provided assume that throughout the event concerned the wager 26 is still capable of a successful outcome. However, in modern sporting competitions in particular, there is the potential for a wager 26 to be in a position where it is no longer capable of meeting a successful outcome even before the event (or series of events) is completed. As an example, a team may have lost several of its pool matches in a tournament and have no mathematical chance of qualifying for a later stage of a tournament. Such a situation is referred to as “dead propositions”

In this respect, the methodology of the third example is capable of being utilised for a range of sporting events in which a wager may be placed on an outcome that later becomes a “dead proposition”. To do so, the following must be taken into consideration.

Where there is a knock out tournament and a proposition becomes dead, there is no change in the actual dividend pool nor the provisional dividends on all of the propositions which remain alive. There is actually no change to the total level of investments in the pool, and the impact—which is of benefit to users with redeemable units 28 on propositions which are still alive—is that the total value of redeemable units 28 on the dead proposition, immediately prior to the point at which the operator declares them a dead proposition, is redistributed to all other users in proportion to their share of the total redemption value pool. This is represented by the following formula;

Re_{d}=N_{d}×RUV_{d}

where:
Re_{d}=Redistribution of Dead Proposition;
N_{d}=Total Number of redeemable units 28 outstanding on the dead proposition immediately prior to the operator declaring it a dead proposition
RUV_{d}=RU Value of dead proposition immediately prior to the operator declaring it a dead proposition

Once Re_{d} has been calculated, users 30 with redeemable units 28 on live propositions receive a proportion of the Re_{d} value. The specific proportion will be determined by each user's RU Value as a percentage of the TRU Value for all units at the time of the redistribution.

### Operator Commissions

It is notable that the system 10 is designed to on average generate the wagering operator a return approximating the wagering pool 24 commission rate. It is possible for the wagering operator's actual commission to vary slightly from the commission rate depending upon the actual cumulative redemption payout position at any moment during the life of a pool. In the third example described above, the dividend pool (total pari-mutuel returns) after transaction 7 is $216 (Spain provisional div of $3.09 multiplied by $70 or Italy provisional div of $1.27 multiplied by $170). There having been no redemption payouts at this stage the operator's commission amounts to $24 (being $240 investments, less $216 dividend pool).

After transaction 8, being the first redemption, the dividend pool reduces by $9 to $207 ($9 representing the $10 amount of the wager 26 being redeemed less ten percent (10%) pool commission). However, the cumulative redemption payouts are $18.89 so the operator's net position if the pool was closed after transaction 8 would be only $14.11—calculated as $240 total pool investments less $18.89 in redemption payouts and dividend pool liability of $207. This represents a return of only five point eighty eight percent (5.88%) rather than the target pool commission of ten percent (10%).

If transaction 8 was in fact a redemption of transaction 3 ($10 wager on Spain, instead of transaction 4 which was a $10 wager on Italy) the net redemption payout (after commission) on transaction 3 would be only $3.72 (because the value of the redeemable units 28 on Spain decreases between the wager at transaction 3 and the redemption at transaction 8). The resulting position to the operator would then be a total return of $29.28 (equating to a twelve point two zero percent (12.20%) return on total pool investments).

Persons skilled in the art would appreciate that the variability of returns to the operator becomes narrower as there are a greater number of transactions within a pool. That is because users will, on average and over time, redeem for a break even position. Every increase in the value of redeemable units 28 for a particular proposition is offset by a corresponding decrease in value redistributed over other propositions in proportion to their share of the total “live” value of all redeemable units 28 at that point in time.

### Essence of the Invention

The person skilled in the art should appreciate that the invention lies in the issuing of the underlying redeemable units 28 in parallel with the confirmation of placement of a pari-mutuel wager 26 into an applicable wagering pool 24 and not in the formulas used to calculate how many redeemable units 28 should be issued for each pari-mutuel wager 26. In this respect, alternative formulae for determining the number of redeemable units 28 to be issued include:

$$N = ( I \times ( 1 - K ) ) \times \frac{{GI}_{proposition}}{{GI}_{pool}}$$

where:
GIₚᵣₒₚₒₛᵢₜᵢₒₙ=the gross proposition investment less the face value of all redeemed units; and
GIₚₒₒₗ=the gross pool investments less the face value of all redeemed units

In the above formulae, the referenced variables have the same meaning as described in the first example where not otherwise defined.

Similarly, the invention should not be considered to be restricted to any one valuation model when calculating the value of each redeemable unit 28.

More importantly, as can be seen from the description of the invention provided above, the invention provides a greater degree of certainty of wager and liquidity than the prior art. Furthermore, as the wagering operator is in essence taking a back bet position in respect of each pari-mutuel wager 26, there is no need for users 30 to operate accounts which require additional capital to hedge against a lost back bet.

It should be appreciated by the person skilled in the art that the above invention is not limited to the embodiment described. In particular, the following modifications and improvements may be made without departing from the scope of the present invention:
At the time a user 30 is required to select a wager type, the user 30 may be presented with the value of redeemable units 28 in addition to the other information mentioned in the above embodiment.
While the formulae for determining the number of redeemable units 28 issued as described in the above embodiment provides for a commission rate (K) on each redeemed unit, the commission rate (K) can be zero.
The predetermined time period up to which a redeemable unit 28 may be redeemed may be determined by the operator of the wagering system 10 at their discretion or may be determined by the rules of the event, or series of events, upon which the pari-mutuel wager 26 is made or by regulations governing the operation of sports wagering on particular events.
The method by which the user 30 indicates the number of redeemable units 28 to be redeemed may be as a strict integer unit value or may be expressed as a percentage of their actual redeemable unit 28 holding.
In a preferred arrangement, the commission rate (K) on each redeemed unit 28 is equal to the wagering pool 24 commission rate applicable in determining the pari-mutuel returns for users 30 who hold successful pari-mutuel wagers 26 at the time of event resolution and who have not redeemed all of their redeemable units 28.
The commission rate (K) may be applied on a contingent basis or on a sliding scale. For instance, the commission rate (K) may be adjusted subsequent to the initial allocation of redeemable units 28 so that it is decreased when applied to users 30 who seek to redeem units 28 at a value below the face value of their original pari-mutuel wager 26.
The commission rate (K) applied to any transaction, or to the wagering pool 24 generally, may be variable and time sensitive such that users who placed a wager 26 earlier in time are subject to a lower commission rate (K) than those who place their wager 26 at a subsequent time.
Redeeming one or more redeemable units 28 may be achieved through automated processes. For instance the user 30 may periodically receive an electronic communication to an appropriate communication device advising as to the current market value of their redeemable units 28 and allowing the user 30 to redeem a certain number of such units 28 through a “one-click” system as would be readily known to the person skilled in the art.
Alternatively, in a further example of an automated redemption process, the user 30 may configure a series of specific redemption conditions associated with the redeemable units 28 using the client-side software 22. The client-side software 22 then communicates these rules to the back-end software 18 that triggers the redemption process in accordance with such rules on each rules associated conditions being met.
In relation to the first and second examples, due to the capacity for each user 30 to redeem any outstanding redeemable units 28 at a time of their choosing, at any point in time there may be uncertainty over the outcome of the prevailing net redemption position as well as the future value of the outstanding redeemable units 28. In the event that at a point in time prior to the closure of the wagering pool 24 users 30 have received cumulative redemption payouts in excess of the cumulative face value of their original pari-mutuel wagers 26, a preferred variation of either example sees the wagering operator carry the prevailing loss at that point in time and make an adjustment, if necessary, to the redeemable value of all other outstanding redeemable units 28 commensurate with the amount of redemption profits generated by the users 30. This approach is consistent with the objective of providing overall returns to users 30 approximating the gross value of the wagering pool 24 less the applicable wagering pool 24 commission whilst reducing the risk to the wagering operator that their returns may vary significantly from the applicable wagering pool 24 commission rate.
In the event of a net redemption loss to users 30, a preferred embodiment is to transfer the redemption profit into the wagering pool 24, which will increase the provisional dividend values of all pari-mutuel wagers 26. This creates extra value for users 30 who have not redeemed as well as facilitating further investment interest by other potential users 30 as the increased values are assessed against alternative wagering products.
The system 10 may seek to provide the user 30 with information regarding the present value of their redeemable units 28 by a variety of channels. As already discussed in the examples provided, communication may be by way of existing wagering infrastructure, such as monitors or TV screens located in betting outlets. However, this may be expanded to allow for communication by way of dedicated sporting broadcasts, whether through terrestrial television or radio technology or through internet-based technologies, such as webcasting or streaming.
The wagering terminal 14 may be a dedicated terminal located at a betting outlet or at the location where the event concerned is conducted. Alternatively, the wagering terminal 14 may be a user's personal or tablet computer or other form of communications device connected to the wagering processor either directly through a wired or wireless network or connected to the wagering processor via the Internet.
The wagering terminal 14 may also be a dedicated hardware device. In such a configuration, the client-side software 22 is implemented in the physical hardware of the wagering terminal 14.
The system 10 may be modified to allow the wagering operator to suspend, either for a time period or indefinitely, the ability to place pari-mutuel wagers 26 on one or more outcomes or to redeem redeemable units 28 associated with a pari-mutuel wager 26 on one or more outcomes.
The client side software 22 may provide to the user 30 details of their current provisional dividend return (i.e. the unit amount of their pari-mutuel wager 26 multiplied by the present provisional dividend value for that pari-mutuel wager 26).
Alternatively or cumulatively, the client side software 22 may also operate to provide to the user 30 details of their current redemption unit value (i.e. the number of redeemable units 28 they have multiplied by the redeemable unit 28 value).
Alternatively, or cumulatively, the client side software 22 may operate to provide to the user 30 both the current provisional dividend return and the current redemption unit 28 value in a number of redeeming scenarios. For instance, these values may be shown on a basis of a 25%, 50%, 75% and/or 100% redemption scenario.
The client side software 22 may include, or integrate with, other software to allow data capture from other informational sources. This can then allow more sophisticated automated redemption conditions to be established for the more sophisticated users 30. As an example, the software may seek to capture details of weather forecasts for an event from the primary meteorological website for the area where the event is to be conducted. Using this information, if one of the teams has a proven track record of weaker performance in the rain, the user 30 may then set up an automated redemption condition that immediately initiates a redemption if the captured weather information forecasts rain for the time that, or a predetermined time before, the event is to be conducted.
The system 10 may incorporate rounding arrangements to ensure that the financial model concerned remains profitable. Such rounding arrangements may apply to the number of redeemable units 28 issued as well as rounding of actual payouts. Alternatively, the system 10 may deal with the number of redeemable units 28 issued as well as the rounding of actual payouts as real numbers up to a fixed number of decimal points.
The system 10 may operate to record details of the pari-mutuel wager 26 and the underlying redeemable units 28 by way of an account, card or voucher system.
Payment by, and to, the user 30 may be through an account held with the wagering operator. Alternatively, such payments may be made through electronic card processing.
While the system 10 in effect places an objective market valuation on the pari-mutuel wager 26 and/or the underlying redeemable units 28, to allow full market valuations to take place, the system 10 may further include a secondary exchange in which the pari-mutuel wagers 26 and redeemable units 28 can be traded. It should be noted that due to the linked nature of the pari-mutuel wager 26 to the redeemable unit 28, one cannot be traded without the other. Thus, while the exchange can provide for trading of a number of redeemable units 28, the trade must also transfer a corresponding proportion of the original pari-mutuel wager 26. Similarly, where the exchange provides for trading of the original pari-mutuel wager 26, this will also transfer the associated proportion of underlying redeemable units 28.
To assist users 30 in liquidating their pari-mutuel wagers 26, the formula used to determine the number of redeemable units 28 to be issued may be skewed to provide a larger number of redeemable units 28. However, this comes at the price of a decreased redemption value which may deter users 30 from placing further pari-mutuel wagers 26.
In situations where a user 30 has placed multiple bets on the same outcome (and thus received redeemable units 28 in two or more tranches), the system 10 may operate either to settle the associated pari-mutuel wagers 26 on a first in time basis, last in time basis, or let the user 30 decide which of the pari-mutuel wagers 26 is to be settled (in whole or in part) by the redemption.
In order to encourage users 30 to wager on one or more outcomes at the initial stages of operation, the wagering operator may seed the appropriate wagering pool 24. The amount seeded may be a fixed amount or calculated by way of a seeding formula. In the latter case, the formula may allow for seeding in stages as the overall wagering pool 24 size meets certain milestones.
Similarly, a matching formula may be used to redeem the seeded amount as certain milestones are met.
While the invention has been described in the context of a wagering pool(s) 24 for simple bets, wagering pools 24 can also be established to handle pari-mutuel returns on each type of exotic bet type, such as trifectas. These additional wagering pools 24 may supplant or run alongside the wagering pool(s) 24 for simple bets.
The RU values for the first and second examples may be calculated on a before investment or after investment basis. In the former calculations the value does not factor into its respective calculations the contemplated investment or redemption, while the latter does.
The system 10 may incorporate minimum pari-mutuel returns (e.g. $1.04 for each $1 invested) so that users 30 are not in a position where the amount received in the form of a final dividend on a successful pari-mutuel wager 26 is less than the original amount paid.
The system 10 may be developed so that the overall net redemption position is not transferred to the wagering pool 24 and instead the wagering operator may assume a greater level of financial risk and reward by having exposure to either profits or losses on redemptions.
The wager processor 12 and wager terminal 14 may have a dedicated data and control connection operating through a network other than the Internet or through other data communication mediums.
The user 30 may place pari-mutuel wagers 26 and initiate redemptions of redeemable units 28 through interactive voice recognition techniques.
The wager processor 12 may be integrated with a wager terminal 14.
The system 10 whilst suited to sports and race betting also has applications in financial markets. For example a pari-mutuel wagering pool 24 with time sensitive redeemable units 28 could be established for a basket of currencies, commodities or stocks with pari-mutuel returns payable to investors whose particular currency, commodity or stock achieved the greatest relative increase in value during the life of the wagering pool 24.
In a variation of the preferred example mentioned above, customers 30 may be given indications of the pre- and post-wager positions such as amount of redeemable units to be issued; gross investment, provisional dividends, amongst others. Such information can then be used by the customer prior to confirming the placement of the wager.
In order to ensure the accuracy of pre- and post-wager positional information, the system 10 may be adapted to “hold” the positional values for a pre-set time period (eg. 30 seconds) so as to ensure that the customer 30 is making their confirmation on reasonably reliable information.
Additional functionality may be built into the system to allow a customer 30 to run a series of “what if” propositions through a simulator. The simulator may be completely divorced from the pari-mutuel wagers already placed on the event or may use the current data as the basis for the “what if” scenario concerned.
A set of rules for determining when a wager is to be placed may be formulated by a customer and facilitated by way of the wagering system. In this respect, their operation would be similar to the proposed rule sets for redeeming of redeemable units 28.
Customers may be presented with historical information regarding their wagers and/or the value of the underlying redeemable units 28. Such information may be presented in tabular or graphical form.
While the invention is most suitable for use in a pari-mutuel wagering system there is no reason why the use of underlying time-sensitive redeemable units can not also be applied to fixed odds betting systems.
The wagering operator may seek to obtain its commission not be imposition of a commission payment. Rather, the wagering operator may see to obtain its commission by issuing a lesser number of redeemable units than they would otherwise be entitled to in accordance with the examples provided above.
Ideally, a commission is only taken from the wagering pool 24 and one other element of the system, such as on completion of a redemption.
While the examples provided above describe the user as being able to provide the necessary details for a wager by way of a graphical user interface, it is open to the system to allow such details to be provided by way of a series of textual commands or by optical character recognition systems.
While the above examples have been described in the context of each wager type having a single wagering pool from which to determine provisional dividends and redeemable unit valuations, it is possible for one or more wagering types to have their value determined with reference to a single wagering pool.
While the invention has been described in the context of its use within the industrial field of gambling and wagering, the invention has equal application to games generally.

It should be further appreciated by the person skilled in the art that the invention is not limited to the embodiments described above. Additions or modifications described, where not mutually exclusive, can be combined to form yet further embodiments that are considered to be within the scope of the present invention.

1-173. (canceled)

174. A wagering system comprising:
a wager processor; and
at least one wager terminal in data and control communication with the wager processor;
where the wager processor is operable to issue a plurality of redeemable units linked to a wager placed by a user on an outcome of an event, or series of events, placed by way of the wager terminal, the number of redeemable units so issued being a function of at least the time at which the wager is placed on said outcome.

175. A wagering system according to claim 174, where the value of each redeemable unit sought to be redeemed is a function of at least the status of wagering at the time of placement of the wager and the status of wagering at the time of redemption of the redeemable unit.

176. A wagering system according to claim 174, where the amount to be paid to the user following redemption of at least one redeemable unit is calculated according to the following formula:
RP=N×RU Value×(1−K)
where:
RP=redemption payout amount.
N=number of redeemable units tendered for redemption.
K=commission rate on redemption payout.
RU Value=current value of a redeemable unit for the outcome the subject of the linked wager.

177. A wagering system according to claim 174, where each redeemable unit's value is determined according to the following formula:
$$RU Value = \frac{1}{PR}$$
where:
RU Value=value of a redeemable unit for the outcome the subject of the linked wager.
PR=potential return for the linked wager.

178. A wagering system according to claim 176, where the RU Value factors in the impact of the redeemable units being tendered for redemption.

179. A wagering system according to claim 177, where an adjustment is made to the value of all redeemable units commensurate with the value of redemption profits made by users at the time of the adjustment.

180. A wagering system according to claim 174, where following each tender of at least one redeemable unit for redemption, the wager processor operates to calculate a settled bet percentage and following calculation, to reduce the amount of the linked wager by an amount proportional to the settled bet percentage.

181. A wagering system according to claim 180, where the settled bet percentage is calculated according to the following formula:
$$SBP = {\sum }_{i = 1}^{j} \frac{{N}_{i}}{RUI}$$
where:
j=total number of times at least one redeemable unit has been tendered for redemption.
Nᵢ=number of redeemable units tendered for redemption as part of the applicable tender.
RUI=original number of redeemable units issued to the linked wager.

182. A wagering system according to claim 174, where the number of redeemable units issued by the wager processor is also a function of at least the current value of all redeemable units issued in respect of the outcome the subject of the wager.

183. A wagering system according to claim 182, where the number of redeemable units issued by the wager processor is calculated according to the formula:
$$N = \frac{( I \times ( 1 - K ) )}{RU Value}$$
where:
N=number of redeemable units to be issued.
I=amount of the linked wager (as a unit value representation).
K=commission rate on allocation of a redeemable unit.
RU Value=current value of a redeemable unit for the outcome the subject of the linked wager.

184. A wagering system according to claim 174, where the number of redeemable units issued by the wager processor is calculated according to the formula:
N=I×PR
where:
N=number of redeemable units to be issued.
I=amount of the linked wager (as a unit value representation).
PR=potential return for the wager at its time of placement.

185. A wagering system according to claim 184, where the PR value factors in the impact of the wager being placed on the potential return of the wager.

186. A wagering system according to claim 174, where the number of redeemable units issued by the wager processor is calculated according to the formula:
$$N = \frac{I}{RU Value}$$
where:
N=number of redeemable units to be issued.
I=amount of the linked wager (as a unit value representation).
RU Value=current value of each redeemable unit.

187. A wagering system according to claim 186, where the RU value is updated after the placement of a new wager and also on redemption of at least one redeemable unit.

188. A wagering system according to claim 186, where the RU value is a function of the value of all redeemable units not yet redeemed in respect of a proposition divided by the value of all redeemable units for all propositions.

189. A wagering system according to claim 174, where the wager processor calculates the potential return for a wager based on the value of the non-redeemed portion of all amounts wagered on the outcome minus a commission amount.

190. A wagering system according to claim 189, where the value of the non-redeemed portion of all amounts wagered on the outcome takes into account the amount of any new wager placed and/or the amount of any new redemptions.

191. A wagering system according to claim 174, where the wager placed is a fixed-odds wager.

192. A wagering system according to claim 174, where each provisional dividend for an outcome and the value of each redeemable unit related to wagers of at least two wagering types is determined by reference to the value of a single wagering pool.

193. A wagering system according to claim 174, where the user is able to specify a set of redemption conditions relating to a wager using client software, the client software operable to communicate the set of redemption conditions to the wager processor such that, when the set of redemption conditions is met, the wager processor automatically operates to redeem a specified quantity of the user's redeemable units linked to that wager.

194. A wagering system according to claim 174, where the user is presented with details regarding the number and/or value of redeemable units to be issued in respect of a wager proposed to be placed.

195. A wagering system according to claim 174, where the value of each redeemable unit is, at least in part, a function of the following equation:
$${PTRU}_{p 1} = \frac{{N}_{p 1} \times RU {Value}_{p 1}}{TRU {Value}_{- 1}}$$
where:
PTRUₚ₁ is the percentage of total redeemable unit value for a particular proposition prior to the wager being placed;
Nₚ₁ is the number of redeemable units 28 outstanding on the particular proposition prior to the wager 26 being placed;
RU Valueₚ₁ is the redeemable unit value for the particular proposition prior to the wager 26 being placed; and
TRU Value₋₁ is the total redeemable unit value for all propositions.

196. A wagering system according to claim 195, where the TRU Value₋₁ variable is calculated in accordance with the following formula:
$$TRU {Value}_{- 1} = {\sum }_{i = 1}^{n} {N}_{pi} \times RU {Value}_{pi}$$
where n is the number of propositions.

197. A wagering system according to claim 195, where the value of each redeemable unit is also, at least in part, a function of the following equation:
IRU Valueₚ₁=Nₚ₁×RU Valueₚ₁+Iₚ₁
where:
IRU Valueₚ₁=the indicative RU total value of outcome; and
Iₚ₁=amount of the new wager placed on outcome.

198. A wagering system according to claim 197, where the value of each redeemable unit is also, at least in part, a function of the following equation:
$$PTRU {Value}_{adj \%} = \frac{IRU {Value}_{p 1}}{TRU Value}$$
where:
TRU Value is the total redeemable unit value for all outcomes inclusive of the value of the new wager.

199. A wagering system according to claim 198, where the value of each redeemable unit is also, at least in part, a function of the following equation:
TRU Valueₛ=PTRU Value_{adj %}×TRU Value₋₁

200. A wagering system according to claim 199, where the value of each redeemable unit is a function of the following equation:
$$RU {Value}_{p 1} = \frac{TRU {Value}_{s}}{{N}_{p 1}}$$

201. A wagering system according to claim 174, where at least one of the wager terminals is one of the following: a dedicated terminal located at a betting outlet or the location where an event on which a wager can be placed is conducted; a software application executable on a notebook computer; a software application executable on a tablet computer; a software application executable on an internet-enabled mobile phone.

202. A wager processor for use with a wagering system according to claim 174, where when the wager processor receives details from a wager terminal of a wager placed by a user on an outcome of an event, or series of events, by way of the wager terminal, the wager processor operates to issue a plurality of redeemable units linked to the wager, the number of redeemable units so issued being a function of at least the time at which the wager is placed on said outcome.

203. A wager processor according to claim 202, where the wager processor is operable to determine the value of a redeemable unit sought to be redeemed as a function of at least the status of wagering at the time of placement of the wager and the status of wagering at the time of redemption of the redeemable unit.

204. A wager processor according to claim 202, where following redemption of at least one redeemable unit, the amount paid to the user is calculated according to the following formula:
RP=N×RU Value×(1−K)
where:
RP=redemption payout amount.
N=number of redeemable units tendered for redemption.
K=commission rate on redemption payout.
RU Value=current value of a redeemable unit for the outcome the subject of the linked wager.

205. A wager processor according to claim 202, where the wager processor determines the current value of each redeemable unit according to the following formula:
$$RU Value = \frac{1}{PR}$$
where:
RU Value=value of a redeemable unit for the outcome the subject of the linked wager.
PR=potential return for the linked wager.

206. A wager processor according to claim 204, where the wager processor factors in the impact of the redeemable units being tendered for redemption in calculating the RU Value.

207. A wager processor according to claim 206, where the wager processor makes an adjustment to the value of all redeemable units commensurate with the value of redemption profits made by users at the time of the adjustment.

208. A wager processor according to claim 202, where following each tender of at least one redeemable unit for redemption, the wager processor operates to calculate a settled bet percentage and following calculation, to reduce the amount of the linked wager by an amount proportional to the settled bet percentage.

209. A wager processor according to claim 208, where the settled bet percentage is calculated according to the following formula:
$$SBP = {\sum }_{i = 1}^{j} \frac{{N}_{i}}{RUI}$$
where:
j=total number of times at least one redeemable unit has been tendered for redemption.
Nᵢ=number of redeemable units tendered for redemption as part of the applicable tender.
RUI=original number of redeemable units issued to the linked wager.

210. A wager processor according to claim 202, where the number of redeemable units issued by the wager processor is also a function of at least the current value of all redeemable units issued in respect of the outcome the subject of the wager.

211. A wager processor according to claim 210, where the number of redeemable units issued by the wager processor is calculated according to the formula:
$$N = \frac{( I \times ( 1 - K ) )}{RU Value}$$
where:
N=number of redeemable units to be issued.
I=amount of the linked wager (as a unit value representation).
K=commission rate on allocation of a redeemable unit.
RU Value=current value of a redeemable unit for the outcome the subject of the linked wager.

212. A wager processor according to claim 202, where the number of redeemable units issued by the wager processor is calculated according to the formula:
N=I×PR
where:
N=number of redeemable units to be issued.
I=amount of the linked wager (as a unit value representation).
PR=potential return for the wager at its time of placement.

213. A wager processor according to claim 212, where the wager processor factors in the impact of the wager being placed on the potential return of the wager in determining the PR value.

214. A wager processor according to claim 202, where the number of redeemable units issued by the wager processor is calculated according to the formula:
$$N = \frac{I}{RU Value}$$
where:
N=number of redeemable units to be issued.
I=amount of the linked wager (as a unit value representation).
RU Value=current value of each redeemable unit.

215. A wager processor according to claim 214, where the wager processor operates to automatically update the current value of each redeemable unit following the placement of a new wager or the redemption of at least one redeemable unit.

216. A wager processor according to claim 214, where the wager processor operates to determine the current value of each redeemable unit as a function of the value of all redeemable units not yet redeemed in respect of a proposition divided by the value of all redeemable units for all propositions.

217. A wager processor according to claim 202, where the wager processor calculates the potential return for a wager based on the value of the non-redeemed portion of all amounts wagered on the outcome minus a commission amount.

218. A wager processor according to claim 217, where the wager processor takes into account the amount of any new wager placed and/or the amount of any new redemptions in determining the value of the non-redeemed portion of all amounts wagered on the outcome.

219. A wager processor according to claim 202, where the wager processor determines the provisional dividend for each outcome and the value of each redeemable unit related to wagers of at least two wagering types by reference to the value of a single wagering pool.

220. A wager processor according to claim 202, where the wager processor is operable to receive a set of redemption conditions specified by the user relating to a wager using client software, and where, when the received set of redemption conditions is met, the wager processor automatically operates to redeem a specified quantity of the user's redeemable units linked to that wager.

221. A wager terminal in data and control communication with a wager processor according to claim 202, the wager terminal operable to receive details from a user of a wager on an outcome of an event, or series of events, and communicate the details to the wager processor, the wager processor thereafter operable to issue a plurality of redeemable units linked to the wager, the number of redeemable units so issued being a function of at least the time at which the wager is placed on said outcome.

222. A wager terminal according to claim 221, where the user enters in the set of wagering information through one of the following: a graphical user interface; optical character recognition scan of a wager card; interactive voice recognition techniques.

223. A wager terminal according to claim 221, where the wager terminal is operable to initiate placement of a wager when a set of wagering conditions is met.

224. A wager terminal according to claim 221, where the wager terminal operates to present the user with details regarding the number and/or value of redeemable units to be issued in respect of a wager proposed to be placed.

225. A wager terminal according to claim 221, the wager terminal taking one of the following forms: a dedicated terminal located at a betting outlet or the location where an event on which a wager can be placed is conducted; a software application executable on a notebook computer; a software application executable on a tablet computer; a software application executable on an internet-enabled mobile phone.

226. A method of operating a wagering system comprising the steps of:
placing a wager on an outcome of an event, or series of events; and
issuing a number of redeemable units linked to the wager, the number of redeemable units so issued being a function of at least the time at which the wager is placed on said outcome.

227. A method of operating a wagering system according to claim 226, including the step of valuing each redeemable unit, the value of each redeemable unit being a function of at least the status of wagering at the time of placement of the wager and the status of wagering at the time of redemption of the redeemable unit.

228. A method of operating a wagering system according to claim 226, further including the step of calculating the amount to be paid to the user following redemption of at least one redeemable unit according to the following formula:
RP=N×RU Value×(1−K)
where:
RP=redemption payout amount.
N=number of redeemable units tendered for redemption.
K=commission rate on redemption payout.
RU Value=current value of a redeemable unit for the outcome the subject of the linked wager.

229. A method of operating a wagering system according to claim 226, further including the step of determining each redeemable unit's value according to the following formula:
$$RU Value = \frac{1}{PR}$$
where:
RU Value=value of a redeemable unit for the outcome the subject of the linked wager.
PR=potential return for the linked wager

230. A method of operating a wagering system according to claim 228, further including the step of factoring in the impact of the redeemable units being tendered for redemption when calculating the RU Value.

231. A method of operating a wagering system according to claim 228, further comprising the step of making an adjustment to the value of all redeemable units commensurate with the value of redemption profits made by users at the time of the adjustment.

232. A method of operating a wagering system according to claim 226, including the step of calculating a settled bet percentage following the tender of at least one redeemable unit for redemption; and the step of reducing the amount of the linked wager by an amount proportional to the settled bet percentage.

233. A method of operating a wagering system according to claim 232, where the step of calculating the settled bet percentage is calculated according to the following formula:
$$SBP = {\sum }_{i = 1}^{j} \frac{{N}_{i}}{RUI}$$
where:
j=total number of times at least one redeemable unit has been tendered for redemption.
Nᵢ=number of redeemable units tendered for redemption as part of the applicable tender.
RUI=original number of redeemable units issued to the linked wager.

234. A method of operating a wagering system according to claim 226, where the number of redeemable units issued is also a function of at least the current value of all redeemable units issued in respect of the outcome the subject of the wager.

235. A method of operating a wagering system according to claim 234, where the number of redeemable units issued is calculated according to the formula:
$$N = \frac{( I \times ( 1 - K ) )}{RU Value}$$
where:
N=number of redeemable units to be issued.
I=amount of the linked wager (as a unit value representation).
K=commission rate on allocation of a redeemable unit.
RU Value=current value of a redeemable unit for the outcome the subject of the linked wager.

236. A method of operating a wagering system according to claim 226, where the number of redeemable units issued is calculated according to the formula:
N=I×PR
where:
N=number of redeemable units to be issued.
I=amount of the linked wager (as a unit value representation).
PR=potential return for the wager at its time of placement.

237. A method of operating a wagering system according to claim 236, where the PR value factors in the impact of the wager being placed.

238. A method of operating a wagering system according to claim 226, where the number of redeemable units issued is calculated according to the formula:
$$N = \frac{I}{RU Value}$$
where:
N=number of redeemable units to be issued.
I=amount of the linked wager (as a unit value representation).
RU Value=current value of each redeemable unit.

239. A method of operating a wagering system according to claim 238, comprising the step of updating the RU Value following placement of a new wager.

240. A method of operating a wagering system according to claim 238, further comprising the step of updating the RU Value following redemption of at least one redeemable unit.

241. A method of operating a wagering system according to claim 238, including the step of calculating the RU Value as a function of the value of all redeemable units not yet redeemed in respect of a proposition divided by the value of all redeemable units for all propositions.

242. A method of operating a wagering system according to claim 226, including the step of calculating the potential return for a wager based on the value of the non-redeemed portion of all amounts wagered on the outcome minus a commission amount.

243. A method of operating a wagering system according to claim 242, further including the step of taking into account the amount of any new wager placed and/or the amount of any new redemptions when determining the value of the non-redeemed portion of all amounts wagered on the outcome.

244. A method of operating a wagering system according to claim 226, where the wager placed is a fixed-odds wager.

245. A method of operating a wagering system according to claims 226, further including the step of determining, by reference to the value of a single wagering pool, the provisional dividend for an outcome and the value of each redeemable unit related to wagers of at least two wager types.

246. A method of operating a wagering system according to claim 226, further comprising the steps of:
specifying a set of redemption conditions relating to a wager; and
when the set of redemption conditions is met, automatically initiating a redemption of a specified quantity of the user's redeemable units linked to that wager.

247. A method of operating a wagering system according to claim 226, further comprising the step of presenting the user with details regarding the number and/or value of redeemable units to be issued in respect of a wager proposed to be placed.

248. A computer readable medium having software recorded thereon that, when executed by an appropriate processing device, performs a method of operating a wagering system comprising the steps of:
placing a wager on an outcome of an event, or series of events; and
issuing a number of redeemable units linked to the wager, the number of redeemable units so issued being a function of at least the time at which the wager is placed on said outcome.

249. A computer readable medium having software recorded thereon that, when executed by an appropriate processing device, performs a method of operating a wagering system according to claim 248, including the step of valuing each redeemable unit, the value of each redeemable unit being a function of at least the status of wagering at the time of placement of the wager and the status of wagering at the time of redemption of the redeemable unit.

250. A computer readable medium having software recorded thereon that, when executed by an appropriate processing device, performs a method of operating a wagering system according to claim 249, further including the step of calculating the amount to be paid to the user following redemption of at least one redeemable unit according to the following formula:
RP=N×RU Value×(1−K)
where:
RP=redemption payout amount.
N=number of redeemable units tendered for redemption.
K=commission rate on redemption payout.
RU Value=current value of a redeemable unit for the outcome the subject of the linked wager.

251. A computer readable medium having software recorded thereon that, when executed by an appropriate processing device, performs a method of operating a wagering system according to claim 249, further including the step of determining each redeemable unit's value according to the following formula:
$$RU Value = \frac{1}{PR}$$
where:
RU Value=value of a redeemable unit for the outcome the subject of the linked wager.
PR=potential return for the linked wager.

252. A computer readable medium having software recorded thereon that, when executed by an appropriate processing device, performs a method of operating a wagering system according to claim 250, further including the step of factoring in the impact of the redeemable units being tendered for redemption when calculating the RU Value.

253. A computer readable medium having software recorded thereon that, when executed by an appropriate processing device, performs a method of operating a wagering system according to claim 248, further comprising the step of making an adjustment to the value of all redeemable units commensurate with the value of redemption profits made by users at the time of the adjustment.

254. A computer readable medium having software recorded thereon that, when executed by an appropriate processing device, performs a method of operating a wagering system according to claim 248, including the step of calculating a settled bet percentage following the tender of at least one redeemable unit for redemption; and the step of reducing the amount of the linked wager by an amount proportional to the settled bet percentage.

255. A computer readable medium having software recorded thereon that, when executed by an appropriate processing device, performs a method of operating a wagering system according to claim 254, where the step of calculating the settled bet percentage is calculated according to the following formula:
$$SBP = {\sum }_{i = 1}^{j} \frac{{N}_{i}}{RUI}$$
where:
j=total number of times at least one redeemable unit has been tendered for redemption.
Nᵢ=number of redeemable units tendered for redemption as part of the applicable tender.
RUI=original number of redeemable units issued to the linked wager.

256. A computer readable medium having software recorded thereon that, when executed by an appropriate processing device, performs a method of operating a wagering system according to claim 248, where the number of redeemable units issued is also a function of at least the current value of all redeemable units issued in respect of the outcome the subject of the wager.

257. A computer readable medium having software recorded thereon that, when executed by an appropriate processing device, performs a method of operating a wagering system according to claim 256, where the number of redeemable units issued is calculated according to the formula:
$$N = \frac{( I \times ( 1 - K ) )}{RU Value}$$
where:
N=number of redeemable units to be issued.
I=amount of the linked wager (as a unit value representation).
K=commission rate on allocation of a redeemable unit.
RU Value=current value of a redeemable unit for the outcome the subject of the linked wager.

258. A computer readable medium having software recorded thereon that, when executed by an appropriate processing device, performs a method of operating a wagering system according to claim 248, where the number of redeemable units issued is calculated according to the formula:
N=I×PR
where:
N=number of redeemable units to be issued.
I=amount of the linked wager (as a unit value representation).
PR=potential return for the wager at its time of placement.

259. A computer readable medium having software recorded thereon that, when executed by an appropriate processing device, performs a method of operating a wagering system according to claim 258, where the PR value factors in the impact of the wager being placed.

260. A computer readable medium having software recorded thereon that, when executed by an appropriate processing device, performs a method of operating a wagering system according to claim 248, where the number of redeemable units issued is calculated according to the formula:
$$N = \frac{I}{RU Value}$$
where:
N=number of redeemable units to be issued.
I=amount of the linked wager (as a unit value representation).
RU Value=current value of each redeemable unit.

261. A computer readable medium having software recorded thereon that, when executed by an appropriate processing device, performs a method of operating a wagering system according to claim 260, comprising the step of updating the RU Value following placement of a new wager.

262. A computer readable medium having software recorded thereon that, when executed by an appropriate processing device, performs a method of operating a wagering system according to claim 260, further comprising the step of updating the RU Value following redemption of at least one redeemable unit.

263. A computer readable medium having software recorded thereon that, when executed by an appropriate processing device, performs a method of operating a wagering system according to claim 260, including the step of calculating the RU Value as a function of the value of all redeemable units not yet redeemed in respect of a proposition divided by the value of all redeemable units for all propositions.

264. A computer readable medium having software recorded thereon that, when executed by an appropriate processing device, performs a method of operating a wagering system according to claim 248, including the step of calculating the potential return for a wager based on the value of the non-redeemed portion of all amounts wagered on the outcome minus a commission amount.

265. A computer readable medium having software recorded thereon that, when executed by an appropriate processing device, performs a method of operating a wagering system according to claim 248, further including the step of taking into account the amount of any new wager placed and/or the amount of any new redemptions when determining the value of the non-redeemed portion of all amounts wagered on the outcome.

266. A computer readable medium having software recorded thereon that, when executed by an appropriate processing device, performs a method of operating a wagering system according to claim 248, where the wager placed is a fixed-odds wager.

267. A computer readable medium having software recorded thereon that, when executed by an appropriate processing device, performs a method of operating a wagering system according to claim 248, further including the step of determining, by reference to the value of a single wagering pool, the provisional dividend for an outcome and the value of each redeemable unit related to wagers of at least two wager types.

268. A computer readable medium having software recorded thereon that, when executed by an appropriate processing device, performs a method of operating a wagering system according to claim 248, further comprising the steps of:
specifying a set of redemption conditions relating to a wager; and
when the set of redemption conditions is met, automatically initiating a redemption of a specified quantity of the user's redeemable units linked to that wager.

269. A computer readable medium having software recorded thereon that, when executed by an appropriate processing device, performs a method of operating a wagering system according to claim 248, further comprising the step of presenting the user with details regarding the number and/or value of redeemable units to be issued in respect of a wager proposed to be placed.
